(19) United States
(12) Patent Application Publication
(10) Pub. No.: US 2008/0065448 A1
(43) Pub. Date: Mar. 13, 2008

(54) Methods and apparatus for identifying workflow graphs using an iterative analysis of empirical data

(75) Inventors: David A. Hull, Pittsburgh, PA (US); Norbert Roma, Pittsburgh, PA (US)

Correspondence Address: JONES DAY, 222 East 41st Street, New York, NY, 10017-6702, US

(73) Assignee: Clairvoyance Corporation, Pittsburgh, PA (US)

(21) Appl. No.: 11/517,244

(22) Filed: Sep. 8, 2006

(51) Int. Cl. G06F 9/46

(52) U.S. Cl. 705/8

(57) ABSTRACT

A method and system for generating a workflow graph from empirical data of a process are described. A processing system obtains data corresponding to multiple instances of a process, the process including a set of tasks, the data including information about order of occurrences of the tasks. The processing system analyzes the occurrences of the tasks to identify order constraints. The processing system partitions nodes representing tasks into subsets based upon the order constraints, wherein the subsets are sequence ordered with respect to each other such that all nodes associated with a given subset either precede or follow all nodes associated with another subset. The processing system partitions nodes representing tasks into subgroups, wherein each subgroup includes one or more nodes that occur without order constraints relative to nodes associated with other subgroups. A workflow graph representative of the process is constructed wherein nodes are connected by edges.

### BACKGROUND

1. Field of the Invention

The present disclosure relates to a method and apparatus for generating a workflow graph. More particularly, the present disclosure relates to a computer-based method and apparatus for automatically identifying a workflow graph from empirical data of a process using an iterative algorithm.

2. Background Information

Over time, individuals and organizations implicitly or explicitly develop processes to support complex, repetitive activities. In this context, a process is a set of tasks that must be completed to reach a specified goal. Examples of goals include manufacturing a device, hiring a new employee, organizing a meeting, completing a report, and others. Companies are strongly motivated to optimize business processes along one or more of several possible dimensions, such as time, cost, or output quality.

Many business processes can be modeled with workflows. As used herein, a workflow (also referred to herein as a workflow model) is a model of a set a tasks with order constraints that govern the sequence of execution of the tasks. A workflow can be represented with a workflow graph, which, as referred to herein, is a representation of a workflow as a directed graph, where nodes represent tasks and edges represent order constraints and often task dependencies. Traditionally, in business processes where workflows are utilized, the workflows are designed beforehand with the intent that tasks will be carried out in accordance with the workflow. However, businesses often carry out their activities without the benefit of a formal workflow to model their processes. In such instances, development of a workflow model could provide a better understanding of the business processes and represent a step towards optimization of those processes. However, development of a workflow by hand based on human observations can be a formidable task.

U.S. Pat. No. 6,038,538 to Agrawal, et al., discloses a computer-based method and apparatus that constructs models from logs of past, unstructured executions of given processes using transitive reduction of directed graphs.

The present inventors have observed a further need for a computer-implemented method and system for identifying a workflow based on an analysis of the underlying empirical data associated with the execution of tasks in actual processes used in business, manufacturing, testing, etc., that is straightforward to implement and that operates efficiently.

### SUMMARY

The present disclosure describes systems and methods that can automatically generate a workflow and an associated workflow graph from empirical data of a process using an iterative approach that is straightforward to implement and that executes efficiently. The systems and methods described herein are useful for, among other things, providing workflow graphs to improve the understanding of processes used in business, manufacturing, testing, etc. Improved understanding of such processes can facilitate optimization of those processes. For example, by discovering a workflow model for a given process as disclosed herein, the tasks of the process can be adjusted (e.g., orders and/or dependencies of tasks can be changed), and the impact of such adjustments can be evaluated, e.g., in test scenarios or using simulation data.

According to one exemplary embodiment, a method for generating a workflow graph comprises obtaining data corresponding to multiple instances of a process, the process including a set of tasks, the data including information about order of occurrences of the tasks. The method also comprises analyzing the occurrences of the tasks to identify order constraints among the tasks. The method also comprises partitioning nodes representing tasks into subsets based upon the order constraints, wherein the subsets are sequence ordered with respect to each other such that all nodes associated with a given subset either precede or follow all nodes associated with another subset. The method also comprises partitioning nodes representing tasks into subgroups, wherein each subgroup includes one or more nodes that occur without order constraints relative to nodes associated with other subgroups. The method also comprises constructing a workflow graph representative of the process and representative of relationships between said subsets and said subgroups wherein nodes are connected by edges.

According to another exemplary embodiment, a system for generating a workflow graph comprises a processing system and a memory coupled to the processing system, wherein the processing system is configured to execute the above-noted steps.

According to another exemplary embodiment, a computer-readable medium comprises executable instructions for generating a workflow graph, wherein the executable instructions comprise instructions adapted to cause a processing system to execute the above-noted steps.

### BRIEF DESCRIPTION OF THE FIGURES

FIG. 1 represents a workflow graph for an exemplary process comprising a set of tasks.

FIG. 2 illustrates an example of cyclic tasks.

FIG. 3 illustrates an exemplary workflow subgraph involving an optional task.

FIG. 4 illustrates an exemplary workflow subgraph for an optional task using an OR formulation.

FIG. 5 illustrates an exemplary workflow subgraph that contains order constraints that link nodes in different branches.

FIG. 6 illustrates a flow diagram of a method for generating a workflow graph according to an exemplary embodiment.

FIG. 7A illustrates hypothetical data for the times at which tasks occur for multiple instances of a process.

FIG. 7B illustrates an ordering summary of tasks associated with the hypothetical data of FIG. 7A.

FIG. 7C illustrates an order matrix representative of the hypothetical data of FIG. 7A and ordering summary of FIG. 7B.

FIG. 7D illustrates an alternative order matrix representative of the hypothetical data of FIG. 7A and ordering summary of FIG. 7B.

FIG. 7E illustrates an order data matrix representative of the hypothetical data of FIG. 7A from which order occurrence information and order constraints can be derived.

FIG. 8 illustrates a flow diagram of an exemplary method for partitioning tasks into subsets based upon order constraints.

FIG. 9 illustrates a flow diagram of an exemplary method for partitioning tasks into subgroups of tasks that are executable without order constraints relative to tasks of other subgroups (partitioning into branches).

FIG. 10 illustrates a flow diagram of an exemplary method for identifying subgroups executable with other subgroups (AND branches), and for identifying subgroups executable as alternatives to other subgroups (OR branches).

FIG. 11 illustrates a flow diagram of an exemplary method for arranging branches into groups wherein all Bi, Bj in a given group satisfy a condition F2(Bi, Bj)=true.

FIG. 12 illustrates a flow diagram of an exemplary method for generating a workflow graph according to another embodiment.

FIG. 13 illustrates a flow diagram of an exemplary method for removing one or more order constraints to facilitate generating a workflow graph.

FIG. 14 illustrates a flow diagram of another exemplary method for removing one or more order constraints to facilitate generating a workflow graph.

FIG. 15 illustrates a flow diagram of another exemplary method for removing one or more order constraints to facilitate generating a workflow graph.

FIG. 16 illustrates a flow diagram of an exemplary method for generating a workflow graph according to another embodiment.

FIG. 17 illustrates an exemplary system for generating a workflow graph according to an exemplary embodiment.

FIG. 18 illustrates an exemplary workflow graph derived for the hypothetical data of FIG. 7A.

FIGS. 19A-19D illustrates a hypothetical workflow graph (A) that is inconsistent with the graph model and alternatives for removing order constraints (A, B, C) for providing alternative graphs that are consistent with the graph model.

### DETAILED DESCRIPTION

The present disclosure describes exemplary methods and systems for finding an underlying workflow of a process and for generating a corresponding workflow graph, given a set of cases, where each case is a particular instance of the process represented by a set of tasks. In addition to deriving a workflow from scratch, the approach can be used to compare an abstract process design or specification to the derived empirical workflow (i.e., a model of how the process is actually carried out).

Graph Model Overview

To illustrate some basic concepts and terminology utilized in connection with the graph model associated with the subject matter disclosed herein, a simple example will be described. Input data used for identifying a workflow is a set of cases (also referred to as a set of instances). Each case (or instance) is a particular observation of an underlying process, represented as an ordered sequence of tasks. A task as referred to herein is a function to be performed. A task can be carried out by any entity, e.g., humans, machines, organizations, etc. Tasks can be carried out manually, with automation, or with a combination thereof. A task that has been carried out is referred to herein as an occurrence of the task. For example, two cases (C1 and C2) for a process of ordering and eating a meal from a fast food restaurant might be:
(C1) stand in line, order food, order drink, pay bill, receive meal order, eat meal at restaurant (in that order);
(C2) stand in line, order drink, order food, pay bill, receive meal order, eat meal at home (in that order). Data corresponding to a collection of cases may be referred to herein as a case log file, a case log, or a workflow log.

As reflected above, data for cases can be represented as triples (instance, task, time). In this example, triples are sorted first by instance, then by time. Exact time need not be represented; sequence order reflecting relative timing is sufficient (as illustrated in this example). Of course, actual time could be represented if desired, and further, both a start time and an end time for a given task could be represented in a case log.

For simplicity, each task can be treated as granular, meaning that it cannot be decomposed, and the time required to complete a task need not be modeled. With such treatment, there are no overlapping tasks. Task overlap can be modeled by treating the task start and the task end as separate sub-tasks in the graph model. Any more complex task can be broken down into sub-tasks in this manner. In general, task decomposition may be desirable if there are important dependency relations to capture between one or more of the sub-tasks and some other external task.

The case log file provides the primary components—tasks and order data—for deriving a workflow graph from empirical data. A goal is to derive a workflow graph that correctly models dependency constraints between tasks in the process. Since dependency constraints are not directly observed in data of the type illustrated above, order constraints serve as the natural surrogate for them. Some order constraints will reflect true dependency constraints, some will simply represent standard practice, and some will occur by chance. As a general matter, a process expert can distinguish between these situations based upon a review of the output workflow graph produced by the methods described herein in view of some understanding of the underlying process. However, as described later, the approaches presented herein may be able to recognize and delete order constraints that occur by chance.

The framework for the graph model involves recursive graph building. Each graph is built up from a set of less complex graphs linked together. A node is a minimal graph unit and simply represents a task. Nodes are connected via edges that denote temporal relationships between tasks. Three basic operations can link together nodes or more complex graphs: the sequence operation, the AND operation, and the OR operation.

The sequence operation (→) links a series of graphs together with strict order constraints. For example, consider the following nodes: SL=stand in line, PB=pay bill, and RM=receive meal. Then graph G1=SL→PB, graph G2=PB→RM, and graph G3=SL→PB→RM are all valid sequence graphs, because SL always precedes PB, which always precedes RM. Similarly, graph G4=G1→RM and graph G5=SL→G2 are valid sequence graphs with one level of nesting, and the graphs G3, G4, and G5 are functionally equivalent. The sequence operation (→) between a pair of graphs indicates that the parent graph (on the left) always precedes the child graph (on the right), e.g., SL→PB in the example above. Such ordering requirements may also described herein using an order constraint symbol (<), e.g., SL<PB. When used to describe connections between nodes or graphs herein, the sequence operation reflects a strict order constraint, as noted above. However, it will be appreciated that the sequence operation (→) may also be used herein in describing the particular order between actual occurrences of tasks. In such instances, the sequence operation does not necessarily reflect a strict order constraint for those tasks generally, but instead just represents an observed order for that occurrence. As will be discussed elsewhere herein, an analysis of the sequences of actual occurrences of tasks can be used to determine whether strict order constraints are generally applicable for given types of tasks.

Nodes in the graph are linked together by order constraints. In practice, the order constraints encoded will sometimes indicate dependency structure (e.g., the task on the right cannot be done before the task on the left), but not always. Order constraints in a process may result from many reasons: tradition, habit, efficiency, or too few observed cases. As noted previously, a process expert with some understanding of the underlying process can determine whether order constraints represent true task dependency or not.

The graph model addresses tasks that are not subject to strict sequential order. Non-sequential task structure is modeled with a branching operator, which may also be viewed as a split node. Branches have a start or split point and an end or join point. Between the start and end points are two or more parallel threads of tasks that can be executed. Each of these parallel threads of tasks can be referred to as a “branch.” Two types of branching operation—the AND operation and the OR operation—are described below. In other words, split nodes can be AND nodes or OR nodes. Each operation and its branches can be considered a sub-graph. For all branches stemming from such an operation, there are no ordering links between branches (no order constraints that link nodes between different branches).

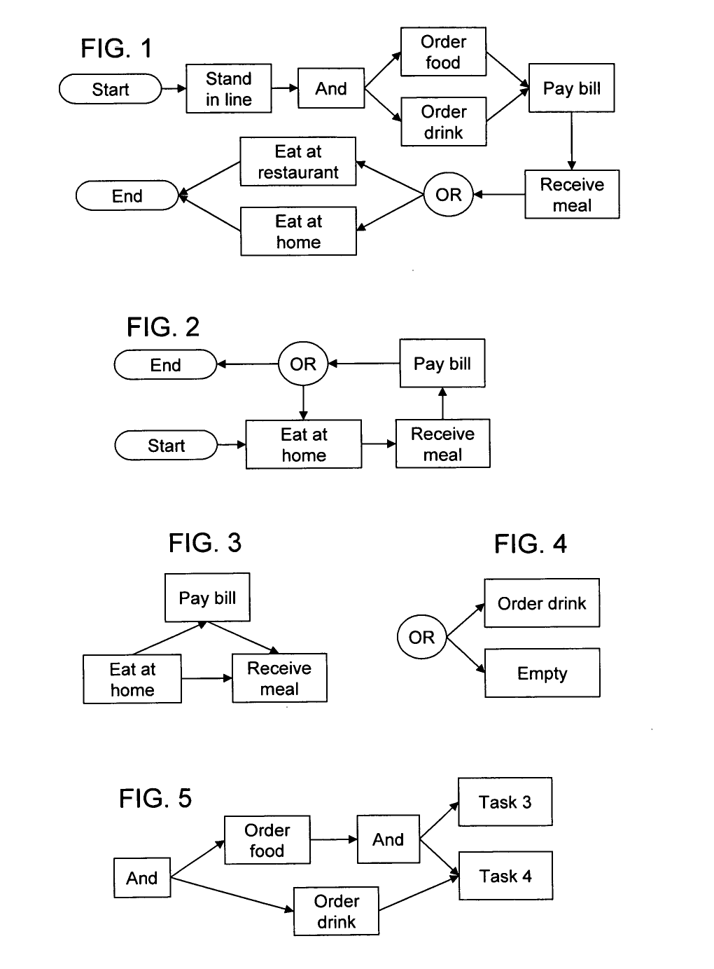

For example, referring to the fast food cases C1 and C2 above, the tasks “order food” and “order drink” (or nodes representing those tasks) can happen in either order. Unordered graphs are partitioned into separate branches using the AND operation. More formally, the AND operation is a branching operation, where all branches must be executed to complete the process. The branches can be executed in parallel (simultaneously), meaning there are no order restrictions on the component graphs or their sub-graphs. The parallel nature of these tasks is reflected in their representation in the graph of FIG. 1, which illustrates a workflow graph representative of the two cases C1 and C2 referred to above. The “order food” and “order drink” branches in this example are basic nodes, but, in general, they could be arbitrary graphs. It will be appreciated that the AND operation can accept any number of branches greater than one.

The graph model also includes tasks that are associated with mutually exclusive events. In the fast food example, it can be assumed that it is not possible to both “eat meal at restaurant” and “eat meal at home” for a given meal. Mutually exclusive graphs are partitioned into separate branches using the OR operation. More formally, the OR operation is a branching operation, where exactly one of the branches will be executed to complete the process. FIG. 1 illustrates the exclusive nature of the “eat meal at restaurant” and “eat meal at home” tasks in the fast food example. The branches in this example are, again, basic nodes, but in general, they could be arbitrary graphs. It will be appreciated that the OR operation can accept any number of branches greater than one.

The example of FIG. 1 represents a workflow graph that can be derived by simple inspection of the cases C1 and C2. In general, however, actual business process can be quite complex. The approaches described herein discover how to partition groups of nodes into appropriate sub-graphs automatically. While the basic operations described above are simple in principle, recursive nesting of graphs joined by these operations can produce complex workflows.

The approaches described herein also address incomplete cases. An incomplete case is a process instance where one or more of the tasks in the process are not observed. This can happen for a number of reasons. For example, the process might have been stopped prior to completion, such that no tasks were carried out after the stopping point. Alternatively or in addition, there may have been measurement or recording errors in the system used to create the case logs. This ability of the approaches described herein to address such cases makes the present approaches quite robust.

Extraneous tasks and ordering errors can also be addressed by methods described herein. An extraneous task is a task recorded in the log file, but which is not actually part of the process logged. Extraneous tasks may appear when the recording system makes a mistake, either by recording a task that didn't happen or by assigning the wrong instance label to a task that did happen. An ordering error means that the case log has an erroneous task sequence, such as (A→B) when the true order of the tasks is (B→A). An ordering error may occur if there is an error in the time clock of the recording system or if there is a delay of variable length between when a task happens and when it is recorded, for example.

Extraneous tasks and ordering errors can be addressed, for example, using an algorithm that identifies order constraints that are unusual and that ignores those cases in developing the workflow. For example, if the case log for a process includes the sequence A→B (i.e., task A precedes task B) for 27 cases (instances) and the sequence B→A for two cases, this may indicate an ordering error or an extraneous instance of A or B in those two unusual cases. Eliminating those two cases from further consideration in a workflow analysis may be desirable. Alternatively, as another example, the data could be retained and simply analyzed from a statistical perspective, such that if the quantity R=(# of times A occurs before B)/(total # of instances in which both A and B occur) exceeds a predetermined threshold (e.g., a threshold of 0.7, 0.8, 0.9, etc.), then an order constraint of A<B can be presumed.

As a general matter, it is convenient to assume under the graph model that the workflow graph is acyclical. This is a reasonable assumption in many cases. Nevertheless, various real-world processes can involve cyclic activities. In this regard, a cyclic sub-graph is a segment of a graph where one or more tasks are repeated in the process, such as illustrated in the example of FIG. 2. The cyclic link (order constraint) must be part of an OR operation in order for such a process to terminate correctly. Cyclic activities can be addressed in various ways in the context of this disclosure. First, in some cases, it may be possible to define a special cyclic-OR operation that includes a sub-graph (possibly empty) that returns to the node from which it started. Alternatively, the workflow algorithm could create a new task node each time a task is repeated (suitable for processes without large frequent cycles). Another approach is to identify the presence of cyclic tasks using conventional pattern recognition algorithms known to those of ordinary skill in the art, and to replace a subset of data representing a plurality of cyclic tasks with a pseudo-task (e.g., a place holder, such as “cycle 1”) for subsequent analysis along with other task data of such a modified case log file according to the methods described herein. Since the tasks of the basic cyclic unit are identified by the pattern recognition algorithm, suitable graph elements representing these tasks can be readily output by the pattern recognition algorithm for later placement into the derived workflow graph.

Optional tasks can also be addressed by the approaches described herein. An optional task is a task that is not always executed and has no alternative task (e.g., OR operation) such as illustrated in the example of FIG. 3. One way to address optional tasks, for example, is to extend the functionality of the OR operation to include an empty task, meaning that when the branch with the empty task is followed, nothing is observed in the log. Another way to address optional tasks, for example, is to add a parameter to each task in order to model the probability that the task will be executed in the process.

Optional tasks present an ambiguity. If a given task is not observed, one does not know whether it is optional or whether there is a measurement error, or both. One way to address this consideration is to assign a threshold for measurement error. Thus, if a task is missing at a rate higher than the threshold, then it is considered to be an optional task. Modeling optional tasks with such node probabilities is attractive since including probabilities is also helpful for quantifying measurement error. It will be appreciated that probabilities for missing/optional tasks in a simple OR branch (i.e., all branches consist of a single node) cannot be estimated accurately without a priori knowledge of how to distribute the missing probability mass over the different nodes.

The workflow discovery algorithms described herein assume that branches are either independent or mutually exclusive to facilitate efficient operation, and the use of the two basic branching operations (OR and AND) in that context excludes various types of complex dependency structures from analysis. Stated differently, ordering links between nodes in different branches should be avoided. Of course, real-world systems can exhibit complex dependencies, such as illustrated in the example of FIG. 5. Such complex dependencies can be addressed by reforming the source of the dependency. For example, many such ordering links are caused by incomplete case data, and these cases can be identified and handled as described in elsewhere herein. Also, such complex dependencies can arise by virtue of how tasks are defined and labeled. Labeling tasks too generally can lead to situations where multiple branches recombine at a given task without termination of the multiple branches. Task 4 in FIG. 5 is an example. By labeling tasks more narrowly, it may be possible to recast Task 4 into two different tasks, e.g., which might be relabeled as Task 4A and Task 4B, such that the recombination of branches at Task 4 in FIG. 5 could be avoided.

With the foregoing overview in mind, exemplary embodiments of workflow discovery algorithms will now be described.

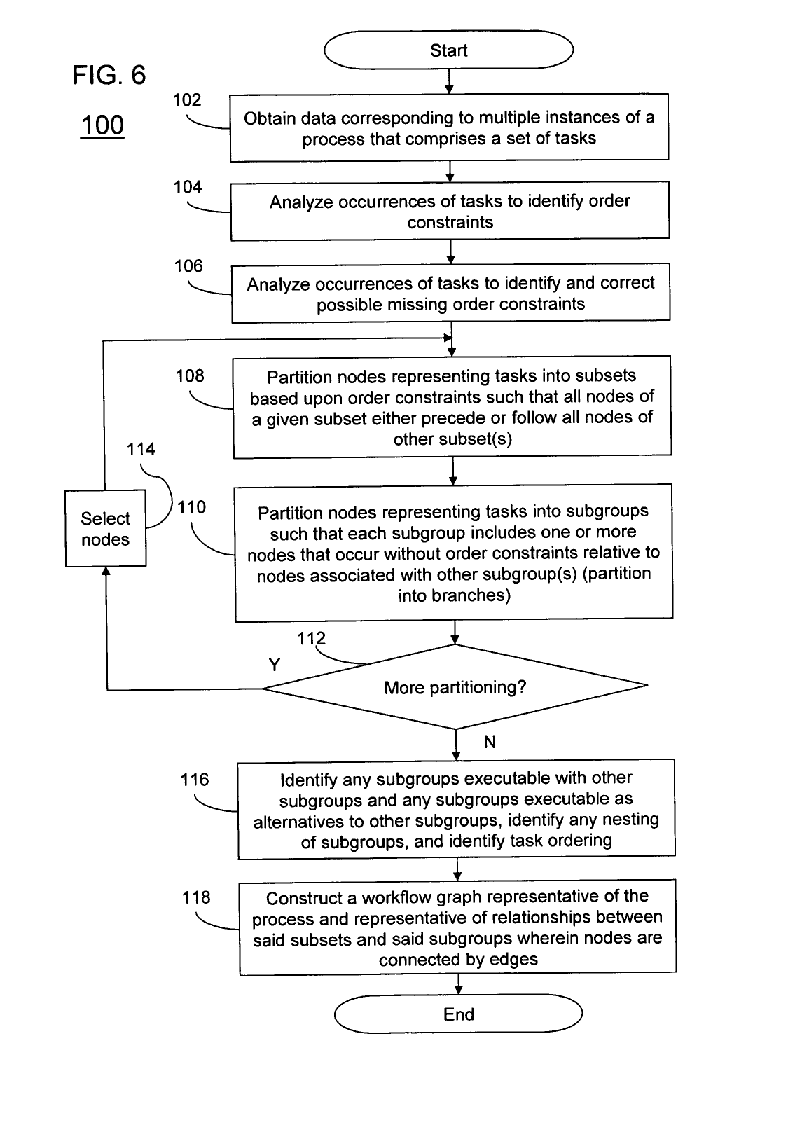

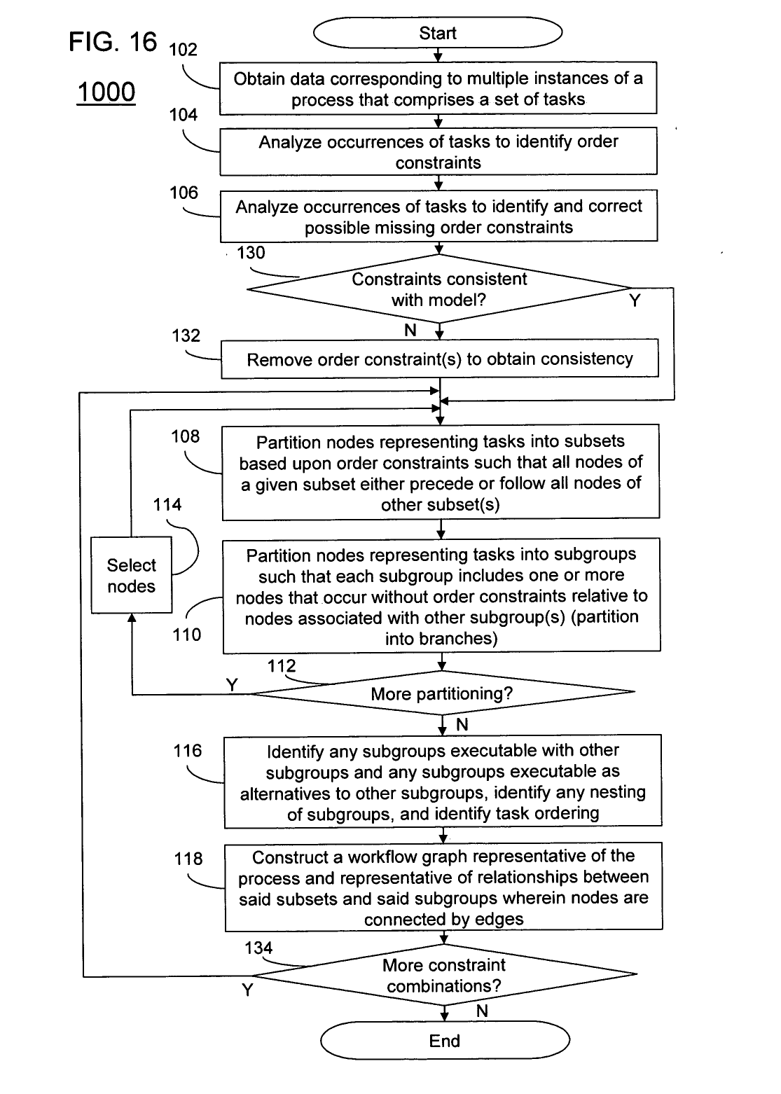

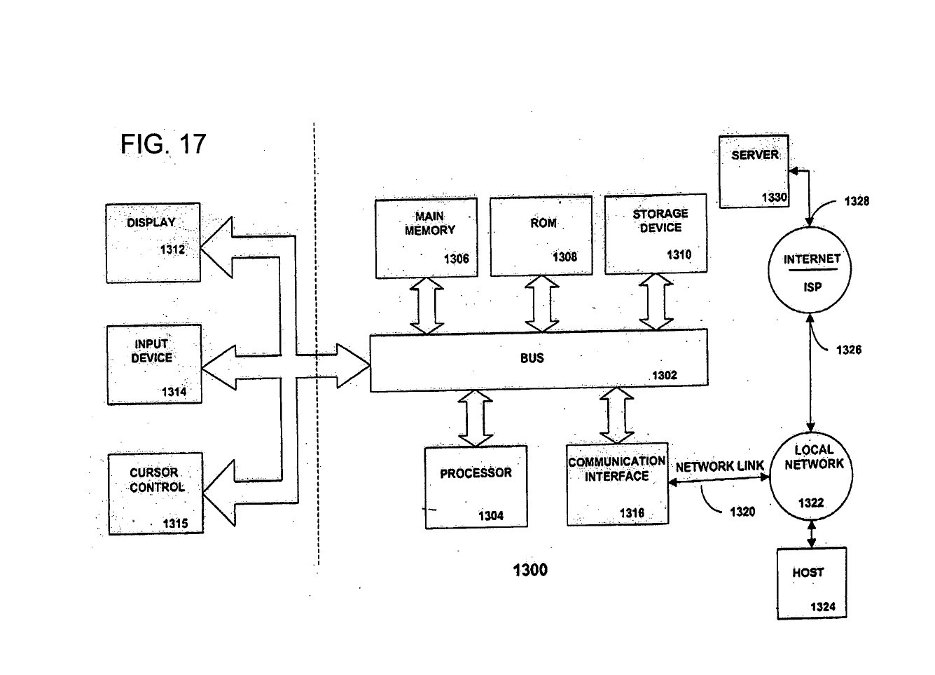

FIG. 6 illustrates a flow diagram for an exemplary method 100 of generating a workflow graph based on empirical data of an underlying process according to an exemplary embodiment. The method 100 can be implemented on any suitable combination of hardware and software as described elsewhere herein. For convenience, the method 100 will be described as being executed by a processing system such as processor 1304 illustrated in FIG. 16. At step 102 the processing system obtains data corresponding to multiple instances of a process that comprises a set of tasks. This data can be in the form of a case log file as mentioned previously herein, wherein the data are already arranged by case (instance) as well as by task identification (labeling) and time sequence. It is not necessary that this information include the actual timing of the tasks. It is sufficient that tasks of a given case are organized in a manner than indicates their relative time sequence (e.g., task A comes before task B, which comes before task C, etc.). Of course, the exact or approximate time of occurrence of tasks can be provided (e.g., including start and end times), and this information can be used to sort the tasks according to time sequence. Any suitable technique for generating a case log file can be used, such as conventional methods known to those of ordinary skill in the art. Such case log files can be generated, for instance, by automated analysis (e.g., automated reasoning over free text) of documents and electronic files relating to procurement, accounts receivable, accounts payable, electronic mail, facsimile records, memos, reports, etc. Case log files can also be generated by data logging of automated processes (such as in an assembly line), etc.

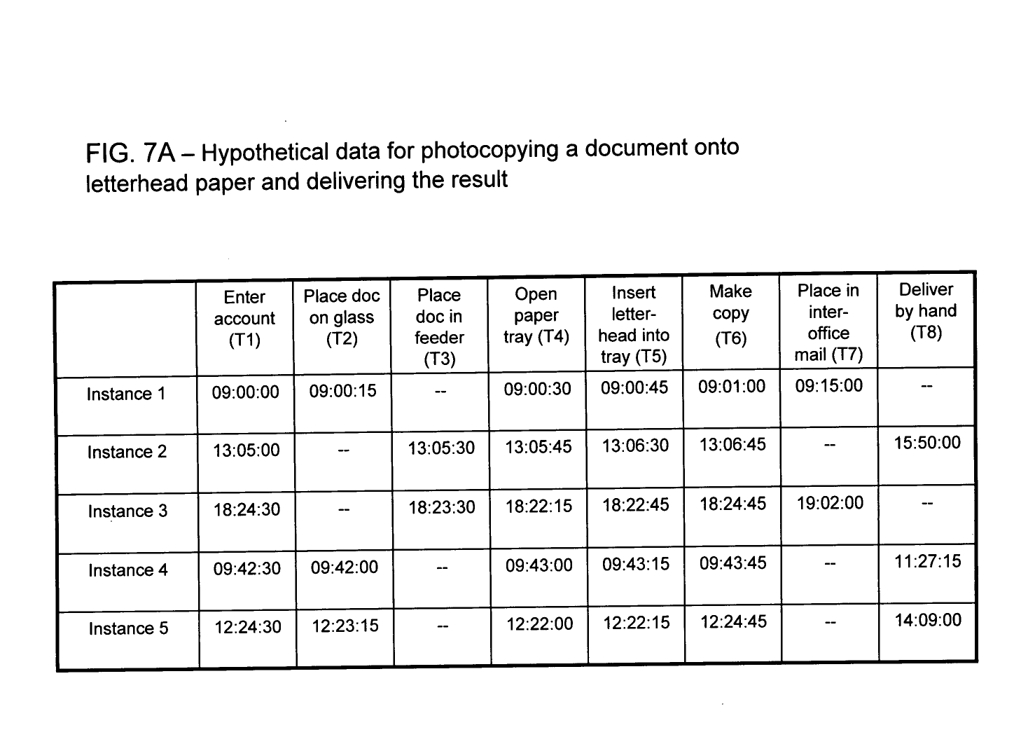

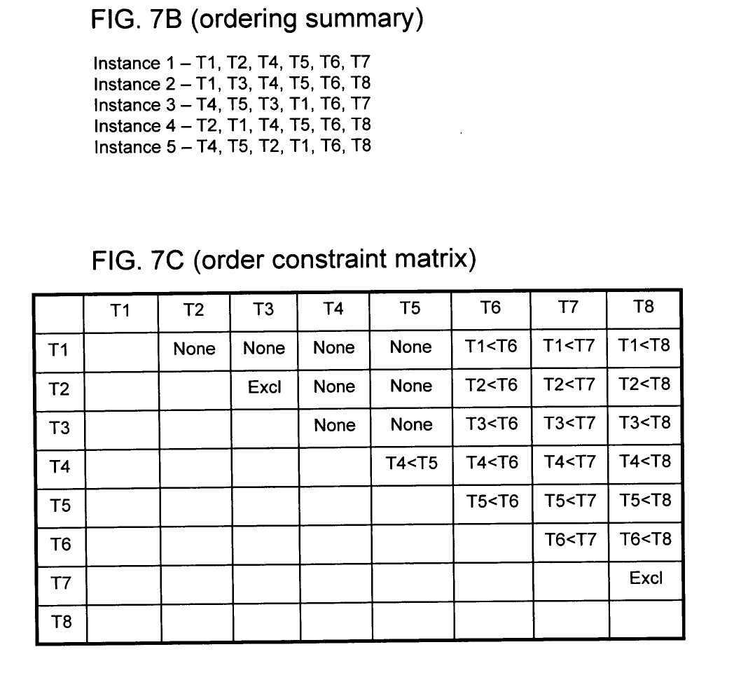

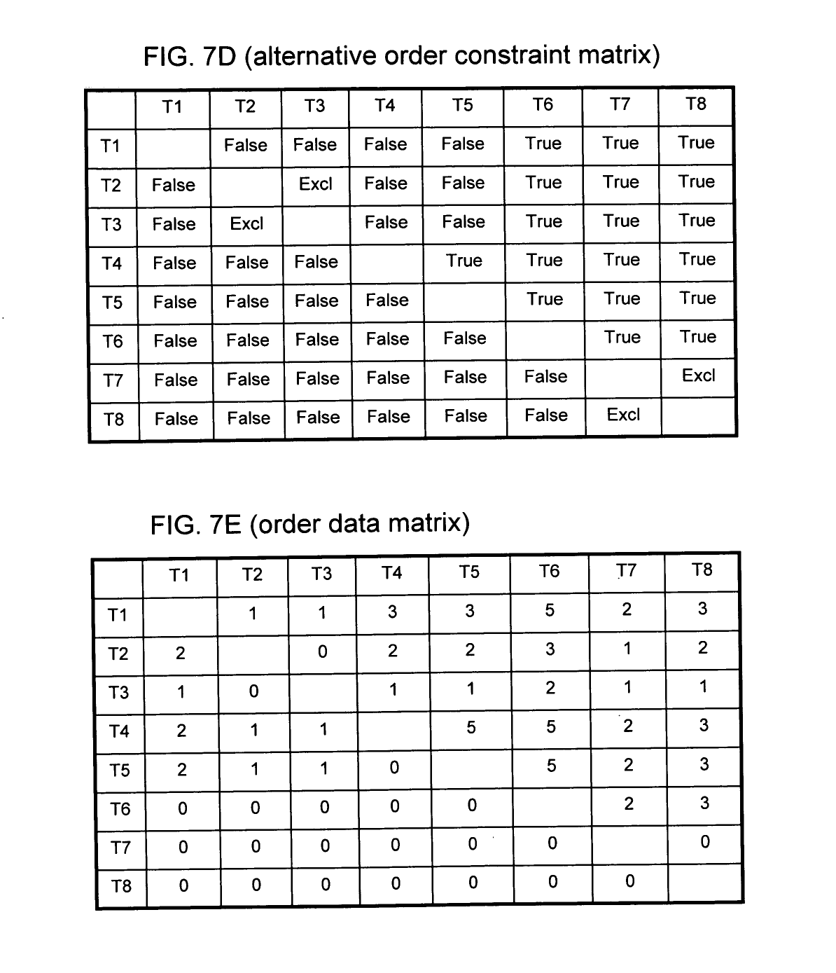

An example of a hypothetical case file is illustrated in FIG. 7A. FIG. 7A illustrates hypothetical data for photocopying a document onto letterhead paper and delivering the result. Data for multiple instances of the process are shown (instance 1, instance 2, etc.). Types of tasks are set forth in columns (enter account, place document on glass, place document in feeder, etc.). The task types are also labeled T1, T2, . . . , T8. Although the task types are numbered in increasing order roughly according to the timing of when corresponding tasks occur, the numerical labeling of task types is entirely arbitrary and need not be based on any analysis of task ordering at this stage. The time at which actual occurrences of tasks occur are reflected in the table of FIG. 7A as illustrated.

FIG. 7B illustrates an ordering summary of the task types associated with the hypothetical data of FIG. 7A. For example, the data for Instance 1 reflects that task T2 occurs after task T1, T4 occurs after T2, T5 occurs after T4, T6 occurs after T5, and T7 occurs after T6. This can be represented in the ordering summary by the simple sequence: T1, T2, T4, T5, T6, T7. It will be appreciated that FIG. 7B can also itself represent a case log file that does not contain numerical time information but instead contains relative timing information for the occurrences of task types. Many variations of suitable case log data and case log files will be apparent to those skilled in the art, and the configuration of case log data is not restricted to examples illustrated herein.

At step 104, the processing system analyzes occurrences of tasks to identify sequence order relationships among the tasks. For example, the processing system can examine the data of the multiple cases to determine, for instance, whether a task identified as task A always occurs before a task labeled as task B in the cases where A and B are observed together. If so, an order constraint A<B can be recorded in any suitable data structure. If task A occurs before task B in some instances and after task B in other instances, an entry indicating that there is no order constraint for the pair A, B can be recorded in the data structure (e.g., “none” can be recorded). If task A is not observed with task B in any instances, an entry indicating such (e.g., “Excl” for “exclusive”) can be recorded in the data structure. This analysis is carried out for all pairings of tasks, and order constraints among the tasks are thereby determined.

An exemplary result of the analysis carried out at step 104 is illustrated in FIG. 7C for the hypothetical data of FIG. 7A. FIG. 7C illustrates an exemplary order constraint matrix that can be used to store the order constraint information determined by analyzing the occurrences of tasks at step 104. As shown in FIG. 7C, the order constraint matrix includes both column and row designations indexed according to task type (e.g., T1, T2, etc.). Inspection of the ordering summary in FIG. 7B reflects that T1 may occur either before or after T2. Accordingly, there is no order constraint between T1 and T2, and the entry for the pair (T1, T2) can be designated with “none” or any other suitable designation. Similarly, there are no order constraints for the pairs T1 and T3, T1 and T4, T1 and T5, T2 and T4, T2 and T5, T3 and T4, and T3 and T5, and these pairs receive entries “none.” Further inspection of the ordering summary of FIG. 7B reflects that T2 and T3 do not occur together in any instance. Accordingly, the entry for the pair T2 and T3 can be designated with the entry “Excl” (exclusive) or with any other suitable designation indicating that these tasks do not occur together. The same is true for the entry for the pair T7 and T8.

Further inspection of the ordering summary of FIG. 7B reveals that for instances in which both T1 and T6 occur, T1 occurs before T6. Accordingly, the entry for the pair T1, T6 can be labeled with a designation T1<T6 (or with any other suitable designation for indicating such an order constraint). Similarly, in all other instances where given pairs occur in the same instance, the ordering summary of FIG. 7B reveals order constraints as indicated in FIG. 7C. As further shown in FIG. 7C, the order constraint matrix need not have entries on both sides of the diagonal of the matrix since the matrix is symmetric in this example. Moreover, the diagonal does not have entries since a given task does not have an order constraint relative to itself. Although the order constraints are illustrated in FIG. 7C as being represented according to a matrix formulation, the order constraint information can be stored in any suitable data structure in any suitable memory.

Thus, one exemplary algorithm for identifying order constraints is as follows:

IF (# times Tᵢ<Tⱼ) ≠ 0 AND (# times Tⱼ<Tᵢ) ≠ 0, THEN there is no
order constraint between Tᵢ and Tⱼ (e.g., T1 occurs before T4
three times, and T4 occurs before T3 once);
IF (# times Tᵢ<Tⱼ) ≠ 0 AND (# times Tⱼ<Tᵢ) ≠ 0, THEN Tᵢ is
constrained to occur before Tⱼ (e.g., T1 occurs before T6 five times, and
T6 occurs before T1 zero times);
IF (# times Tᵢ<Tⱼ) = 0 AND (# times Tj<Ti) = 0, THEN Tᵢ and Tⱼ are
mutually exclusive (e.g., T3 occurs before T2 zero times, and T2 occurs
before T3 zero times).

Another exemplary algorithm for identifying order constraints compares occurrence data to a predetermined threshold, such as follows:

```
For every pair of tasks Tᵢ, Tⱼ that appears in the log
    a. Let N be the number of instances where Tᵢ = 1, Tⱼ = 1 (i.e., a “1”
    indicates that the task occurred in a given instance);
    b. Let Nᵢ be the number of instances where Tᵢ = 1, Tⱼ = 1 and Tᵢ
    appears after Tⱼ;
    c. Let Nⱼ be the number of instances where Tᵢ = 1, Tⱼ = 1 and Tⱼ
    appears after Tᵢ;
    d. If Nᵢ / N > θ
        i. O(i, j) ← true (where O(i, j) is a variable that reflects whether
        task Tᵢ is constrained to occur before task Tⱼ);
    e. Else
        i. O(i, j) ← false;
    f. If Nⱼ / N > θ
        i. O(j, i) ← true;
    g. Else
        i. O(j, i) ← false;
    h. If (O(i, j) == false) and (O(j, i) == false);
        i. O(i, j) = exclusive;
        ii. O(j, i) = exclusive.
```

The value of θ can be application dependent and can be determined using measures familiar to those skilled in the art (e.g., likelihood of the data), or can be determined empirically by analyzing past data for a given process where order constraints are already known, for example. Other approaches for identifying order constraints will be apparent to those of skill in the art.

FIG. 7D illustrates an alterative exemplary order constraint matrix for which the entries are either True, False, or Excl (exclusive). In this example, a row designation (i) is read against a column designation (j) for the proposition i<j, meaning task i is constrained to occur before task j. If task i is constrained to occur before task j (e.g., task i=T1, task j=T6), the entry is True. If task i is not constrained to occur before task j (e.g., task i=T1, task j=T5), the entry is False. As in FIG. 7C, tasks that do not occur together are provided with entries of “Excl” (exclusive).

FIG. 7E illustrates an exemplary order data matrix in which the entries represent the actual number of occurrences for which a task i (row designation) occurred before a task j (column designation). The processing system can be programmed to identify whether or not there is an order constraint from such stored data whenever such a determination is required using suitable algorithms, such as those described above.

At step 106, optionally, the processing system can analyze occurrences of the tasks to identify any possible missing order constraints. This step can occur either before or after step 104. For example, the processing system can assess whether there are any unusual ordering constraints, such as, for instance, Task A occurs before Task B in 50 cases, and Task B occurs before Task A in 2 cases. The latter two orderings may be erroneous and may have occurred, for example, because of task mislabeling, incorrect time identification, etc. In any event, if all 52 orderings for Tasks A and B are accepted as reliable, the processing system would determine that there is no order constraint for task A relative to task B (because A occurs before B in some cases and after B in other cases). However, if the latter two cases are treated as erroneous and ignored with respect to the ordering between A and B, then the processing system would identify an order constraint between tasks A and B, namely, task A occurs before task B (A<B). Thus, the processing system can thereby identify a possible missing order constraint. Of course, the issue of possible missing order constraints can be addressed, if desired, at the stage of evaluating whether or not order constraints exist using a probabilistic, threshold-based approach such as described above.

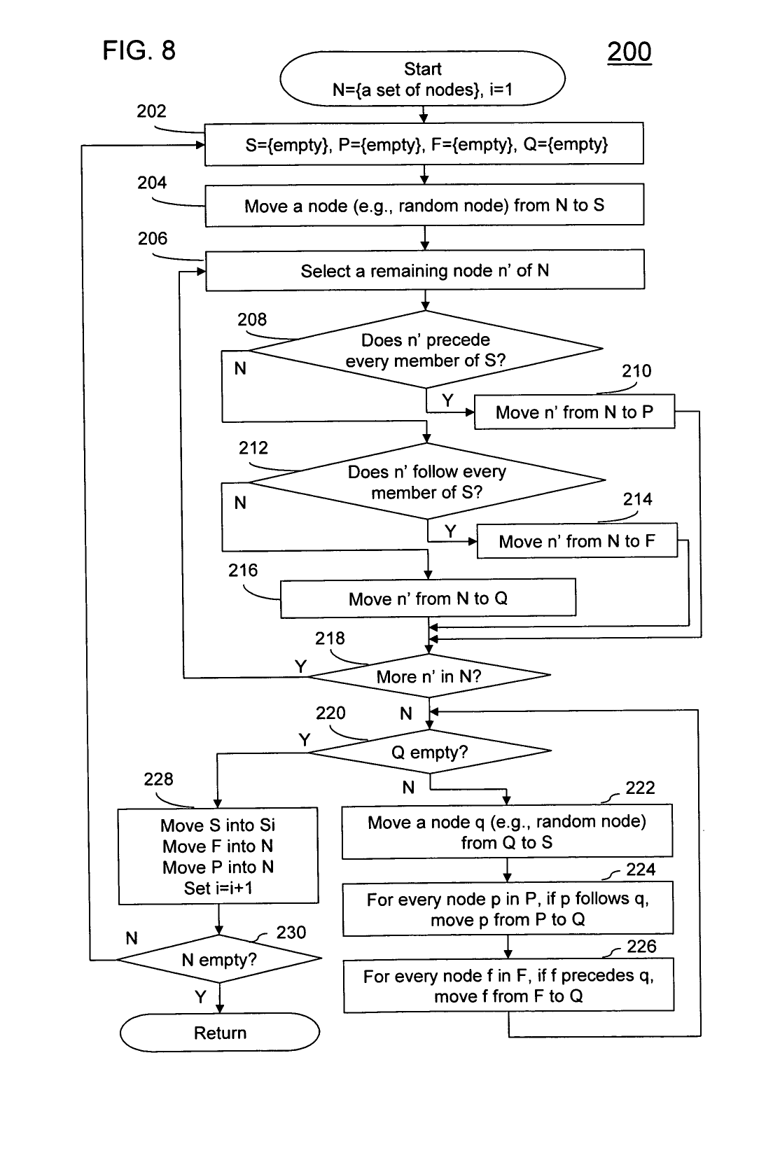

Steps 108 and 110 may occur repeatedly within a loop formed by decision step 112. Although step 108 is shown as occurring before step 110, the order of these steps can be reversed. At step 108, the processing system partitions nodes representing tasks into subsets based upon the sequence order relationships such that all the nodes of one subset either precede or follow all the nodes of another subset or subsets. This step may also be referred to herein as sequence decomposition. It will be appreciated that subsets can include one or more nodes representing tasks. An exemplary approach for partitioning the set of tasks into subsets based on order constraints will be described later in connection with FIG. 8.

It should be noted that at steps 108-118, the processing system is analyzing nodes that symbolically or mathematically represent types of tasks, as opposed to the actual occurrences of tasks, along with corresponding order constraints. As noted previously, the actual occurrences of tasks are instances of tasks actually carried out as reflected by the empirical data in the case log file.

At step 110, the processing system partitions nodes representing tasks into subgroups of tasks that are executable without order constraints relative to tasks of other subgroups. For example, a particular subset of tasks identified at step 108 can be the subject of further partitioning into subgroups at step 110. Such subgroups generated by the partitioning at step 110 are also referred to herein as “branches,” and such partitioning may be referred to as “branch decomposition” herein.

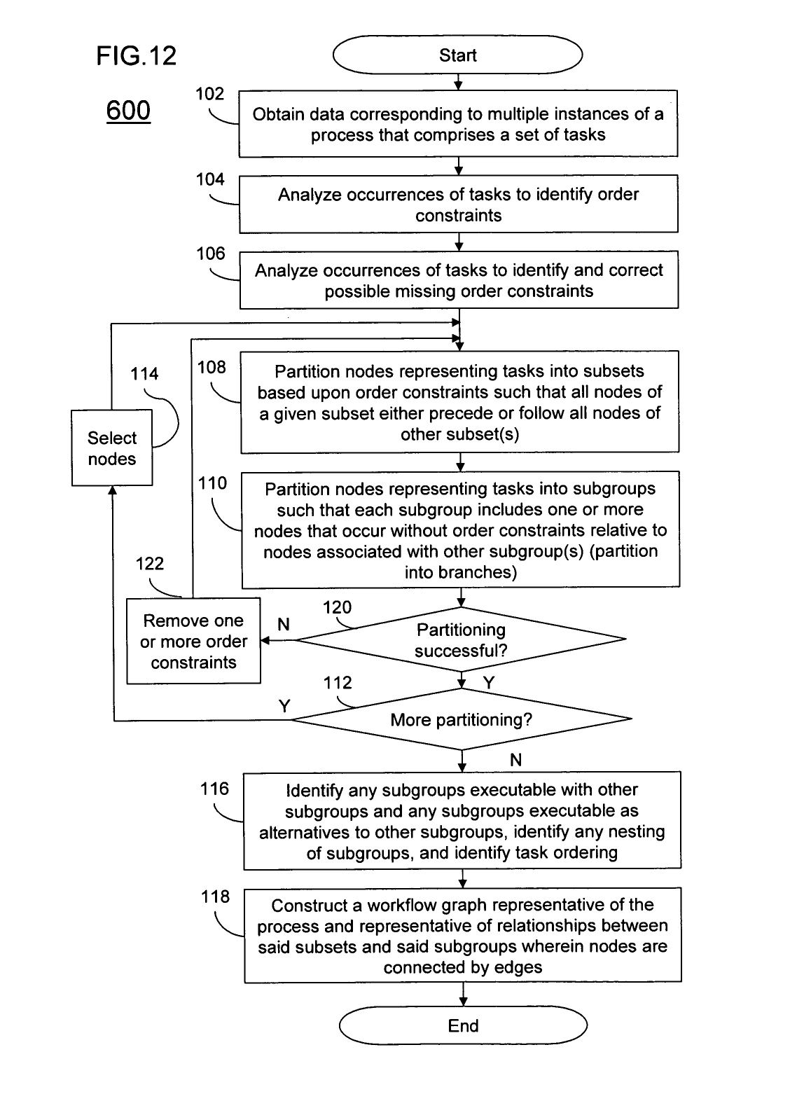

At step 112, a decision is made on whether to continue partitioning. For example, if the branch decomposition step at 110 identifies any branches that contain more than one node, the decision to continue partitioning is “yes.” At step 114, tasks of the branch or branches that contain more than one node can be selected for further sequence decomposition at step 108. The process can continue until each subset identified in a sequence decomposition step is reduced to a single node, as an example. Alternatively, the process can iterate over sequence decomposition at step 108 and branch decomposition at step 110 until a predetermined number of iterations has been achieved, or until a time-out condition has been reached, at which point the decision to continue partitioning can be specified as “no” at step 112. As discussed in connection with FIG. 12 below, the recursive algorithm can temporarily suspend branch and/or sequence decomposition on a given subset or branch that contains nodes but is unpartitionable due to the nature of the ordering constraints among such nodes.

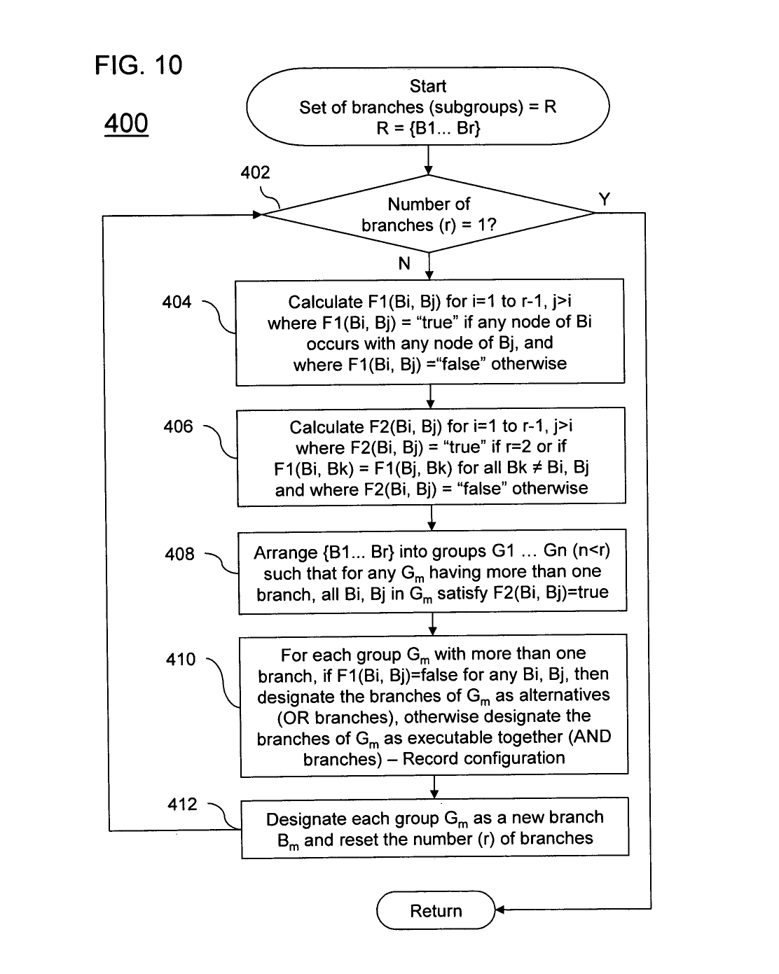

At this point, the processing system can proceed to step 116 and identify any subgroups executable with other subgroups (AND branches) and any subgroups executable as alternatives to other subgroups (OR branches). In other words, a determination can be made as to whether given branches should be connected with AND operations or OR operations. The processing system can also identify any nesting of subgroups (branches), and can carry out a final identification of task ordering. Exemplary approaches for carrying out step 116 will be described later in connection with FIG. 10 herein. The AND and OR branching operators reflecting relationships between nodes can be identified and recorded for all levels of nesting of branches.

At step 118 a graph representative of the workflow process can be constructed, wherein the graph is representative of the process and representative of the identified relationships between the identified subsets and branches, wherein the nodes are connected by edges. Namely, a workflow graph can be constructed by joining branches at all levels of nesting using the stored OR and AND branching operators that reflect relationships between nodes, and by joining nodes with edges based on the stored order constraints. It will be appreciated that a graph as referred to herein is not limited to a pictorial representation of a workflow process but includes any representation, whether visual or not, that possesses the mathematical constructs of nodes and edges. In any event, a visual representation of such a workflow graph can be communicated to one or more individuals, displayed on any suitable display device, such as a computer monitor, and/or printed using any suitable printer, so that the workflow graph may be reviewed and analyzed by a human process expert or other interested individual(s) to facilitate an understanding of the process. For example, by assessing the workflow graph generated for the process, such individuals may become aware of process bottlenecks, unintended or undesirable orderings or dependencies of certain tasks, or other deficiencies in the process. With such an improved understanding, the process can be adjusted as appropriate to improve its efficiency.

An exemplary method for partitioning the set of tasks into subsets based upon sequence order constraints such that all tasks have been given subset either proceed or follow all tasks of other subsets (sequence decomposition—step 108) will now be described. In sequence decomposition, a current set of task nodes is partitioned into the maximal number of node subgroups that can be aligned in a sequence. Let N be a set of nodes. In the first iteration, N can contain all nodes representing all tasks under consideration. In subsequent iterations, N will be a proper subset of the full sample. The goal of the process is to partition N into subsets S₁ . . . Sₙ, each with the following property: all nodes in Sₖ (k≠i) must either precede all nodes in Sᵢ or follow all nodes in Sᵢ. Given a set S, let set P be the set of all nodes that always precede every node in S, let set F be the set of all nodes that always follow every node in S, and let the set Q be the set of any remaining nodes not in S. Each subset Sᵢ can be identified sequentially by the following procedure (in pseudocode):

```
Initialize S = {empty}, P = {empty}, Q = {empty}, F = {empty}, i = 1.
While N is not empty:
  Remove a node n (e.g., random node) from N and add it to S;
  For each node n′ ε N
    If n′ precedes every member of S, move n′ from N to P
    If n′ follows every member of S, move n′ from N to F
    Otherwise, move n′ from N to Q;
  While Q is not empty
    Remove a random node q from Q and add it to S
    For every node p in P, if p follows q at least once, move p
    from P to Q
    For every node f in F, if f precedes q at least once, move
    f from F to Q
  S now defines a valid subset
  Move all nodes from S to Sᵢ, set i = i+1, move nodes from
  P and F back into N.
```

After sequence decomposition, the full set of nodes has been decomposed into sequential subsets S₁ . . . Sₙ.

A corresponding flow diagram of an exemplary method 200 corresponding to the above-described algorithm is illustrated in FIG. 8. At the start of method 200 shown in FIG. 8, the input is a set of nodes representing a set of tasks. The set of nodes could represent the entire set of tasks under consideration if the process 200 is being run for the first time, or the set of nodes may represent a smaller set of tasks identified from a branch decomposition step at step 110 of FIG. 6. At step 202, four sets are assigned to be empty. These are designated in FIG. 8 as set S, set P, set F, and set Q, although any designation could be used. At step 204, a node is moved from set N to set S. For example, the first node in the set N could be chosen, or a random node from set N could be chosen. At step 206, a remaining node n′ of set N is selected. At step 208, the order constraints are examined to determine whether node n′ precedes every member of set S. If the answer is yes, the node n′ is moved from the set N to the set P at step 210. If the answer at step 208 is no, the process 200 proceeds to step 212. At step 212, the order constraints are examined to determine whether the node n′ follows every member of set S. If the answer is yes, the node n′ is moved from the set N to the set F. If the answer at step 212 is no, then the process proceeds to step 216.

If the process proceeds to step 216, the node n′ is moved from the set N to the set Q. Regardless of whether the process executes step 210, step 214, or step 216, the process will proceed to step 218 where a determination is made whether additional nodes n′ still remain in the set N. If the answer at step 218 is yes, the process proceeds back to step 206 where a remaining node n′ of set N is selected for further examination. If the answer at step 218 is no, the process 200 proceeds to step 220.

At step 220, the set Q is tested to determine whether or not the set is empty. If set Q is empty, the process proceeds to step 228 to be discussed below. If set Q is not empty the process proceeds to step 222, and a node q is moved from the set Q to the set S. This could involve either removing the first node or a random node from the set Q, for example. The process then proceeds to step 224 wherein, for every node p in set P, the order constraints are examined to determine whether p follows q, and if so, p is moved from set P to set Q. The process then proceeds to step 226 wherein, for every node f in set F, the order constraints are examined to determine whether f precedes q, and if so, node f is moved from set F to set Q. The process then proceeds back to step 220 and steps 222, 224 and 226 are repeated.

As noted above, if at step 220 it is determined that the set Q is empty, the process proceeds to step 228 wherein all of the contents of set S are moved into subset Sᵢ wherein the contents of set F are moved into set N, and wherein the contents of set P are moved into the set N. In addition, the index i is set to i=i+1. The process then proceeds to step 230 wherein the set N is tested to determined whether or not it is empty. If set N is empty, the process ends. If the set N is not empty, the process 200 returns to step 202 and is executed again. In this manner, the process 200 can partition a input set of nodes N into subsets S₁ . . . Sₙ of nodes such that all nodes of a given subset either proceed or follow all nodes of other subsets.

Thus, it will be appreciated that in this manner, partitioning nodes representing tasks into subsets based upon the order constraints can be accomplished by: (a) selecting a node from a set of nodes representing tasks and assigning said node to a given subset (e.g., S, whose contents will ultimately become S1 in a first iteration, S2 in a second iteration, etc.); (b) assigning nodes not assigned to the given subset to another subset (e.g., Q) unless said nodes not assigned to the given subset either precede or follow all nodes assigned to the given subset based upon the order constraints; (c) while nodes of said another subset (e.g., Q) remain, assigning one or more of the nodes of said another subset to the given subset (e.g., S), and repeating step (b) after each such assignment; and (d) if any nodes of the set of nodes (N) remain unassociated with any subset (e.g., S1, S2, etc.), assigning one of the remaining unassociated nodes to a new subset (e.g., S in a next iteration), and repeating steps (b) and (c) using the new subset in place of the given subset.

An exemplary method for partitioning tasks into subgroups of tasks that are executable without order constraints relative to tasks of other subgroups (branch decomposition—step 110) will now be described. In branch decomposition according to an exemplary embodiment, a current set of nodes is partitioned into the maximal number of node subgroups (branches) that operate in parallel. Branch decomposition can be applied to each subset identified in sequence decomposition with more than one node. Let the set M be the set of all nodes in the current subset Sᵢ. The goal of the process is to partition M into branches B₁ . . . Bₘ each with the following properties: all nodes in Bᵢ must precede or follow at least one other node in Bᵢ (if Bᵢ contains more than one node). All nodes in Bₖ (k≠i) must have no order constraints with any node in Bᵢ. Subgroups can be identified by the following procedure (in pseudocode):

```
Initialize B = {empty}, K {empty}, U = {empty}, i = 1.
While M is not empty:
    Remove a node (e.g., random node) m from M and add it to B;
    Divide M into sets {K, U} where every node in K always precedes or
    always follows at least one member of B and U contains any
    remaining nodes
    While K is not empty
        Remove a random node k from K and add it to B
        For every node u in U, if u precedes or follows k, move
        u from U to K
    B now defines a valid branch.
    Move all nodes from B to Bᵢ, set i=i+1, move nodes from U back
    into M.
```

After branch decomposition, the set of nodes has been decomposed into branches B₁ . . . Bₘ. For each branch (subgroup) with more than one node, the process 100 returns to sequence decomposition (step 108). The recursive algorithm can continue to run until every subset contains only one node, or until a predetermined number of iterations has been achieved, or until time-out condition has occurred, for example. As discussed in connection with FIG. 12 below, the recursive algorithm can temporarily suspend branch and/or sequence decomposition on a given subset or branch that contains nodes but is unpartitionable due to the nature of the ordering constraints among such nodes.

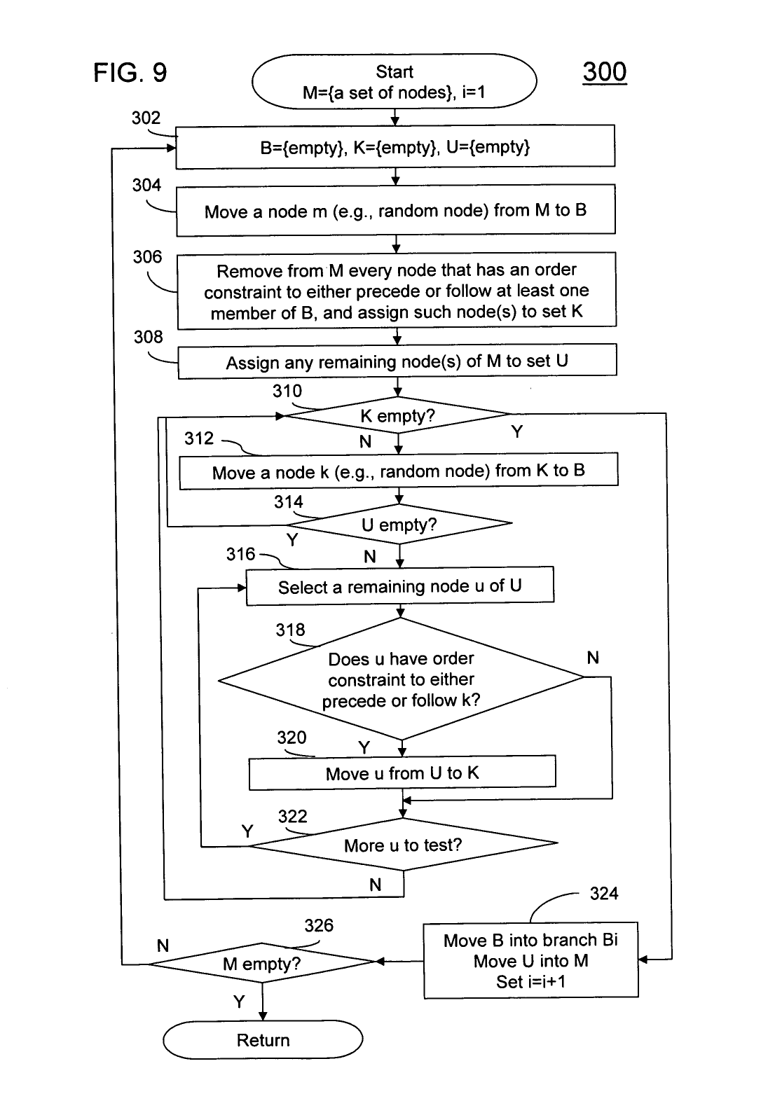

A corresponding flow diagram of an exemplary method 300 corresponding to the above-described algorithm is illustrated FIG. 9. FIG. 9 illustrates an exemplary process 300 for partitioning tasks into branches. The input to the process 300 is a set of nodes M. The set M could be for example a subset of nodes identified from a previous sequence decomposition step at step 108, such as noted above, or could be the entire set of tasks under consideration if branch decomposition is being applied from the outset prior to any sequence decomposition. At step 302, three sets are assigned to be empty. These are illustrated in FIG. 9 as set B, set K, and set U. At step 304, a node m is moved from the set M to the set B. Node m could be, for example a first node of set M, or could be a random node, for example. At 306, every node that has an order constraint to either proceed or follow at least one member of set B is removed from set M, and such nodes are assigned to set K. At step 308, any remaining nodes of set M are assigned to a set U. At step 310 the set K is tested to determine whether or not it is empty. If the set K is not empty, the process proceeds to step 312 wherein a node k is moved from the set K to the set B. Node k could be, for example, a random node of set K or a first node of set K according to some order. The process then proceeds to step 314.

At step 314 the set U is tested to determine whether or not it is empty. If the set U is not empty, the process proceeds to step 316, wherein a remaining node u of set U is selected. At step 318, a determination is made as to whether the node u has an order constraint to either follow or precede node k. If there is such an order constraint, the node u is moved from the set U to the set K. If no such order constraint is identified at step 318, the process skips step 320 then proceeds directly to step 322. Otherwise, the process executes step 320 wherein the node u is moved from set U to set K. At step 322, a determination is made regarding whether the set U contains any additional nodes u to test. If another node u is remaining in set U, the process returns to step 316. If it is determined at step 322 that the set U contains no more nodes u, then the process returns to step 310. In addition, if it is determined at step 314 that the set U is empty, the process returns to step 310.

If it is determined at step 310 that the set K is empty, the process proceeds to step 324. At step 324 the nodes that have been collected thus far into set B are moved into a branch Bi (where i is the index for the current iteration), the contents of the set U are moved into set M, and the index i is updated to i=i+1. At this point the process proceeds to step 326 wherein it is determined whether or not the set M is empty. That is, it is determined whether or not any more of the initial nodes in the set M remain to be processed for branch decomposition. If the set M is empty, the process 300 ends. If the set M is not empty, the process 300 proceeds back to step 302 and repeats. In this manner, one or more iterations can be carried out to assign the nodes of the initial set M into one or more branches Bi.

Thus, it will be appreciated that partitioning nodes representing tasks into subgroups can be accomplished by: (a) selecting a node from a set of nodes (e.g., M) representing tasks and assigning said node to a given subgroup (e.g., B, whose contents will ultimately become B1 in a first iteration, B2 in a second iteration, etc.); (b) assigning nodes not assigned to the given subgroup (e.g., B) to another subgroup (e.g., K) if said nodes not assigned to the given subset possess order constraints with any nodes of the given subgroup; (c) while nodes of said another subgroup (e.g., K) remain, assigning one or more of the nodes of said another subgroup to the given subgroup (e.g., B), and repeating step (b) after each such assignment; and (d) if any nodes of the set of nodes remain unassociated with any subgroup (e.g., B1, B2, etc.), assigning one of the remaining unassociated nodes to a new subgroup (e.g., B in a next iteration), and repeating steps (b) and (c) using the new subgroup in place of the given subgroup.

Referring back to FIG. 6, it will be appreciated that exemplary process 200 for sequence decomposition (FIG. 8) can be used to partition tasks as set forth at step 108 of FIG. 6. Also, the exemplary process 300 for branch decomposition (FIG. 9) can be used to partition tasks into branches at step 110 of FIG. 6. Sequence decomposition at step 108 and branch decomposition at step 110 can be carried out iteratively in a recursive manner via the loop created with decision step 112 until the entire set of tasks under consideration has been reduced to minimal subgroups and minimal branches, or until some other stopping criterion is met (e.g., a certain number of iterations has been carried out, a run time limitation has been exceeded, etc.). As noted previously, the process 100 illustrated in FIG. 6 then proceeds to step 116, wherein the processing system identifies any subgroups executable with other subgroups (AND branches) and identifies any subgroups executable as alternatives to other subgroups (OR branches). The processing system also identifies any nesting of branches, and identifies final task ordering. An exemplary approach for identifying AND branches, OR branches, and nesting of branches will now be described in connection with FIG. 10.

FIG. 10 illustrates an exemplary process 400 for identifying subgroups executable with other subgroups (AND branches) and subgroups executable as alternatives to other subgroups (OR branches). Implicit in the process 400 is also the identification of any nesting of branches, i.e., identification of any branches that exist within other branches.

The process 400 starts with the input being a set of branches (e.g., an entire set of branches determined from one or more iterations of branch decomposition at step 110 of FIG. 6). The set of branches is labeled as set R in FIG. 10, wherein R={B1 . . . Br}. At step 402, the processing system determines whether the number of branches (r) is equal to 1. If r=1, then there is only one branch, and the process 400 ends. If r≠1, the process 400 proceeds to step 404. At step 404, the processing system calculates a function F1(Bi, Bj) for i=1 to r−1, j>i, such that F1(Bi, Bj)=“true” if any node of Bi occurs with any node of Bj, and where F1(Bi, Bj)=“false” otherwise. It will be appreciated that this quantity is symmetric according to i and j. For example, the processing system can access whatever data structure contains the order constraint information (e.g., an order constraint matrix such as illustrated in FIG. 7C, for example) and identifies the order constraint information associated with the given pair Bi, Bj. If the order constraint information for that pair indicates either that there is no order constraint (e.g., “none”) or that there is a particular order constraint, then the processing system determines that the tasks Bi and Bj do occur together, and F1 is set to true. If, on the other hand, the processing system determines at step 404 that the data structure contains an indication that the pair (Bi, Bj) do not occur together (e.g., the order constraint entry for the pair is “Excl” indicating mutual exclusivity), then the processing system determines that tasks Bi and Bj do not occur together, and F1 is set to false.

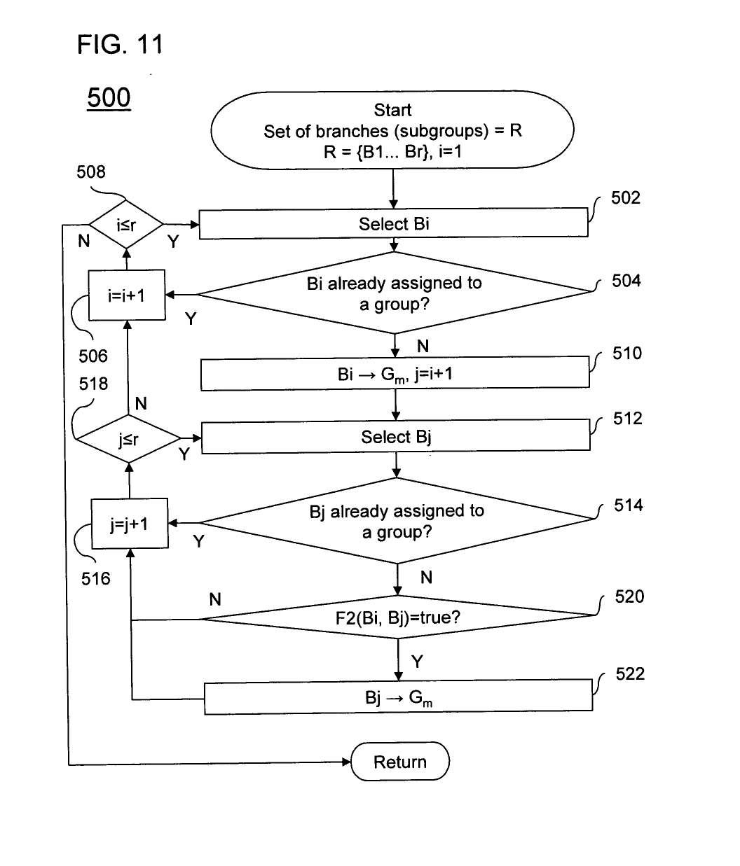

The process 400 then proceeds to step 406. At step 406, the processing system calculates another function F2(Bi, Bj) for i=1 to r−1, j>i, where F2=“true” if r=2, or if F1(Bi, Bk)=F1(Bj, Bk) for all Bk≠Bi, Bj, and where F2(Bi, Bj)=“false” otherwise. The process 400 then proceeds to step 408 where the processing system arranges the branches B1 . . . Br into groups G1 . . . Gn (n≦r) such that for any Gₘ having more than one branch, all Bi, Bj in Gₘ satisfy F2(Bi, Bj)=true. An exemplary approach for carrying out step 408 will be described later in connection with FIG. 11.

The process then proceeds to step 410. At step 410, the processing system examines each group Gₘ with more than one branch, and if F1(Bi, Bj)=false for any Bi, Bj, then the processing system designates the branches of Gₘ as alternatives (OR branches). Otherwise, the processing system designates the branches of Gi as executable together (AND branches). The processing system then records this configuration so that an AND node or OR node can be inserted into the workflow graph at the split point of the branches as appropriate.

The process 400 then proceeds to step 412, wherein the processing system designates each group Gₘ as a new branch Bₘ and resets the number (r) of branches. For example, if the processing system previously arranged three branches into group G1 and two other branches into group G2 such that there are two groups (G1 and G2), the processing system would reset the number of branches from “5” to “2.” At this point the process returns to step 402 wherein the processing system determines whether or not the number of branches (r) equals 1. If the number of branches equals 1, the process ends. In this manner, the process 400 will iterate recursively until the processing system designates the entire set of branches as a single branch. During each iteration, the processing system records in a suitable data structure the branch configuration of each that iteration (including whether branches split in an AND fashion or an OR fashion) so as to maintain an identification of the branch structure for any arbitrary level of nesting of branches. At some iteration, multiple branches will be designated as a single branch, which will be detected at step 402 (r=1), and the process 400 will end.

An exemplary approach for carrying out step 408 of FIG. 10 will now be described in connection with FIG. 11. FIG. 11 illustrates and exemplary method 500 for arranging branches B1 . . . Br into groups G1 . . . Gn (n<r) such that for any Gₘ having more than one branch, all Bi, Bj in Gₘ satisfy F2(Bi, Bj)=true. The input to method 500 is the set of branches R where R={B1 . . . Br}. An index i is initialized to i=1 at the start of method 500. At step 502, branch Bi is selected (e.g., branch B1 in a first iteration). At step 504 the processing system determines whether Bi is already assigned to a group G, e.g., whether Bi has been associated with a group G in any suitable data structure stored in a memory. Step 504 can be skipped, of course, for i=1 (the first iteration), since it is assumed that the branch B1 has not yet been associated with a group G. If it is determined at step 504 that branch Bi is already assigned to a group G, the method 500 proceeds to step 506 where the index i is incremented to i=i+1. The method 500 then proceeds to step 508 where the processing system determines whether i≦r (where r is equal to the number of branches input to the method 500). If it is determined at step 508 that i≦r, then the method 500 returns to step 502, otherwise the process 500 ends.

If it is determined at step 504 that branch Bi is not assigned to a group G, then the method 500 proceeds to step 510 where branch Bi is assigned to group Gₘ, and where the index j is set to j=i+1. The process 500 then proceeds to step 512 wherein a branch Bj is selected. At step 514 the processing system determines whether branch Bj is already assigned to a group G. If branch Bj is already assigned to a group G, the process 500 proceeds to step 516 where index j is incremented to j=j+1. The process 500 then proceeds to step 518 where the processing system determines whether j≦r. If j≦r, the process 500 proceeds back to step 512 where the next branch Bj is selected; otherwise, the process 500 proceeds to step 506 described above.

If it is determined at step 514 that the branch Bj is not already assigned to a group G, the process proceeds to step 520 where the branches Bi and Bj are tested to determine whether the function F2(Bi, Bj)=true, where the function F2 is defined as previously set forth herein. If F2(Bi, Bj) is equal to “true” at step 520, then the process 500 proceeds to step 522, wherein the branch Bj is assigned to the group Gi along with branch Bi. If F2(Bi, Bj) is not equal to “true” at step 520 (i.e., F2=false), then the process 500 proceeds back to step 516. In this manner, a single branch or multiple branches can be arranged into group, and the remainder of process 400 illustrated in FIG. 10 can then be executed to determine whether the branches of such groups form OR branches or AND branches (step 410) and to designate each such group as a new branch (step 412) for further iterative analysis in process 400.

If the data used to generate the order constraints are complete and if the order constraints do not include constraints related to ordering links between nodes in different branches, the sequence decomposition at step 108 of FIG. 6 and the branch decomposition at step 110 of FIG. 6 will converge. If these conditions are not met, it is possible that the method 200 in FIG. 6 will stall. To address this possibility, another exemplary embodiment that selectively removes order constraints to facilitate generating the workflow graph will be described in connection with FIG. 12.

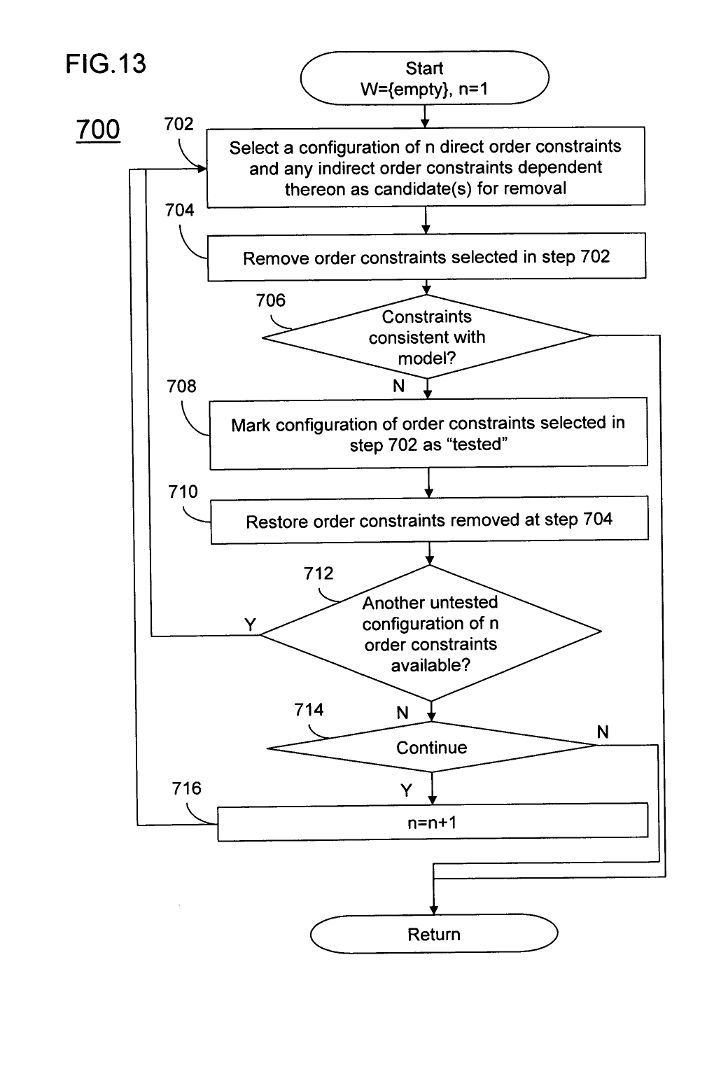

FIG. 12 illustrates a flow diagram for an exemplary method 600 of generating a workflow graph based on empirical data of an underlying workflow process according to another exemplary embodiment. Steps 102-118 of FIG. 12 are the same as steps 102-118 of FIG. 6, which have already been described herein. Accordingly, further discussion of those steps will be skipped here. In comparison to FIG. 6, FIG. 12 includes additional steps 120 and 122. At step 120, which occurs after the sequence decomposition step 108 and branch decomposition step 110, the processing system evaluates whether partitioning at steps 108 and 110 has been successful for the current iteration. For example, if there are any subsets or any branches with more than one node from a previous iteration, but sequence decomposition at step 108 and/or branch decomposition at step 110 is unable to further partition such a subset or branch, then the processing system determines that partitioning has not been successful. At that point, the process 600 proceeds to step 122 wherein one or more order constraints are removed. A variety of automated approaches for removing one or more order constraints will be described below in connection with FIGS. 13-15. Alternatively, human intervention can optionally be used at step 122 to remove order constraints based upon knowledge of the underlying workflow process if the number of nodes in a current inconsistent subset or branch is sufficiently low so as to be amenable to human review. If the number of nodes is large, it will generally be preferable to permit automated removal of one or more order constraints. A motivation for removing one or more order constraints is to permit branch decomposition and sequence decomposition to continue as previously described herein.

FIG. 13 illustrates an exemplary process 700 for removing one or more order constraints (e.g., at step 122 of FIG. 12). Step 700 begins by assigning a set W to be empty and by setting an index n=1. At step 702 the processing system selects a configuration of direct order constraints as candidates for removal. Where n=1, the processing system identifies configurations in which one direct order constraint is a candidate for removal. Where n=2, the processing system identifies configurations in which two order constraints are candidates for removal. It will be appreciated that a configuration in which two particular order constraints, e.g., first and second order constraints, are identified as candidates for removal is different from another configuration in which a different pair of order constraints is identified for possible removal (e.g., the second order constraint and a third order constraint). Thus, for any given value of n, there may be many possible configurations of order constraints that could be removed. It should be understood that a direct order constraint is an order constraint that relates the order of two nodes x, y such that there is no additional node z identified among the order constraints that could be a link in a path from node x to node y. For example, referring to the order constraint matrix of FIG. 7C, it will be observed that the order constraint T4<T6 would be considered indirect, i.e., not direct, because there is an intervening node T5 that could provide a link in a path from node T4 to node T6 as evidenced by the order constraints T4<T5 and T5<T6. Conversely, the order constraint T4<T5 is a direct order constraint, because there is no potentially intervening node between nodes T4 and T5 reflected in the order constraint matrix of FIG. 7C. The configuration of direct order constraints selected at step 702 can be selected at random, for example, or can be selected in numerical order based on how the order constraints are indexed, as another example. Of course, any other suitable approach for selecting a configuration of direct order constraints at step 702 could be used. In addition, all indirect order constraints that are dependent on a direct order constraint considered for removal are also flagged as candidates for removal. An indirect order constraint I is dependent on a direct order constraint D if there is no other path implied by the order constraint information between the source node and the target node of I.

At step 704, the order constraints selected at step 702 are removed by the processing system. For example, this could mean that those order constraints are actually erased from whatever data structure stores order constraint information, or that those order constraints are suitably flagged so as to be identified as “removed.” At step 706, a determination is made as to whether the remaining order constraints are now consistent with the graph model. The order constraints are consistent with the graph model if any nodes that share a parent node have exactly the same set of parents. In this regard, if there is a direct order constraint x<y, then x is the parent of y, and y is a child of x. If there is also a direct order constraint x<z, then y and z are siblings. Thus, a graph is consistent with the graph model if all sibling nodes have exactly the same set of parents. If it is determined that step 706 that the order constraints are now consistent with the model the method returns back to the main process 600 (FIG. 12) for further sequence and branch decomposition.

If, however, it is determined at step 706 that the order constraints are still not consistent with the model, the method proceeds to step 708, and the processing system marks the configuration of order constraints selected at step 702 as “tested.” The method then proceeds to step 710, wherein the processing system restores the order constraints removed at step 704. At 712, the processing system determines whether there exists another untested configuration of order constraints available. If the answer to the query at step 712 is “yes,” the process returns to step 702, and the processing system selects another untested configuration of order constraints as a candidate for removal and proceeds through the remaining steps as described above. If the answer to the query at step 712 is “no” (no untested configuration of order constraints remains for the present value of n), then the processing system proceeds to step 714. At step 714, the processing system makes a determination as to whether to continue to attempt to remove order constraints. For example, the processing system could test whether the current value of n is equal to a predetermined value (e.g., n=2, 3, etc.) such that the process of removing order constraints should terminate. Alternatively, the condition at step 714 could test whether or not a run time condition has been met, or whether a predetermined number of iterations of the method 700 has already occurred. If it is determined at step 714 to continue to attempt to remove order constraints, the method proceeds to step 716 wherein the processing system increments the index n to be n=n+1. The method then returns to step 702 and the process is repeated except that now the processing system attempts to remove a larger number of order constraints associated with any given configuration (because n has been incremented to a higher value).

It will be appreciated that the condition evaluated at step 712 assesses configurations of direct order constraints tested as opposed to whether simply individual order constraints have been tested. This is because removing a given order constraint in combination with another order constraint is different than removing the given order constraint in combination with yet a different order constraint (e.g., the removal of an order constraint T3<T4 in combination with an order constraint T5<T6 can yield a different result than removal of the constraint combination T3<T4 and T7<T8).

As described in the example above, method 700 terminates immediately upon finding a set of order constraints that can be removed to generate a graph consistent with the graph model. In a variation, steps 702-712 can be repeated until multiple, (e.g., all) sets of direct order constraints of size n have been tested. If more than one set of direct order constraints of size n can be removed to create a consistent workflow graph, a human domain expert can choose among these configurations, if desired. Otherwise, the algorithm can continue as described previously. If multiple configurations are retained, method 1000 of FIG. 16 can be used for an implementation of the overall workflow graph generation process.

Ultimately, the method 700 will terminate and overall execution will return to method 600 of FIG. 12, wherein sequence decomposition at step 108 and branch decomposition at step 110 can be continued. When the process 600 again reaches step 120, the processing system will evaluate whether partitioning has been successful. If it is determined at step 120 that partitioning for that iteration was not successful, the process 600 continues to step 112, and the processing system can make a determination as to whether to continue partitioning, such as described previously. For example, if the partitioning was unsuccessful only for a particular collection of nodes, the processing system can avoid further attempts at branch and sequence decomposition on those nodes and can continue to step 114 to select another set of nodes for further processing. When a determination is made at step 112 to refrain from further partitioning, the method 600 proceeds to step 116. In this manner, the processing system can attempt to process multiple collections of nodes of the entire set of nodes and ultimately carry out steps 116 and 118, such as described previously in connection with FIG. 6.

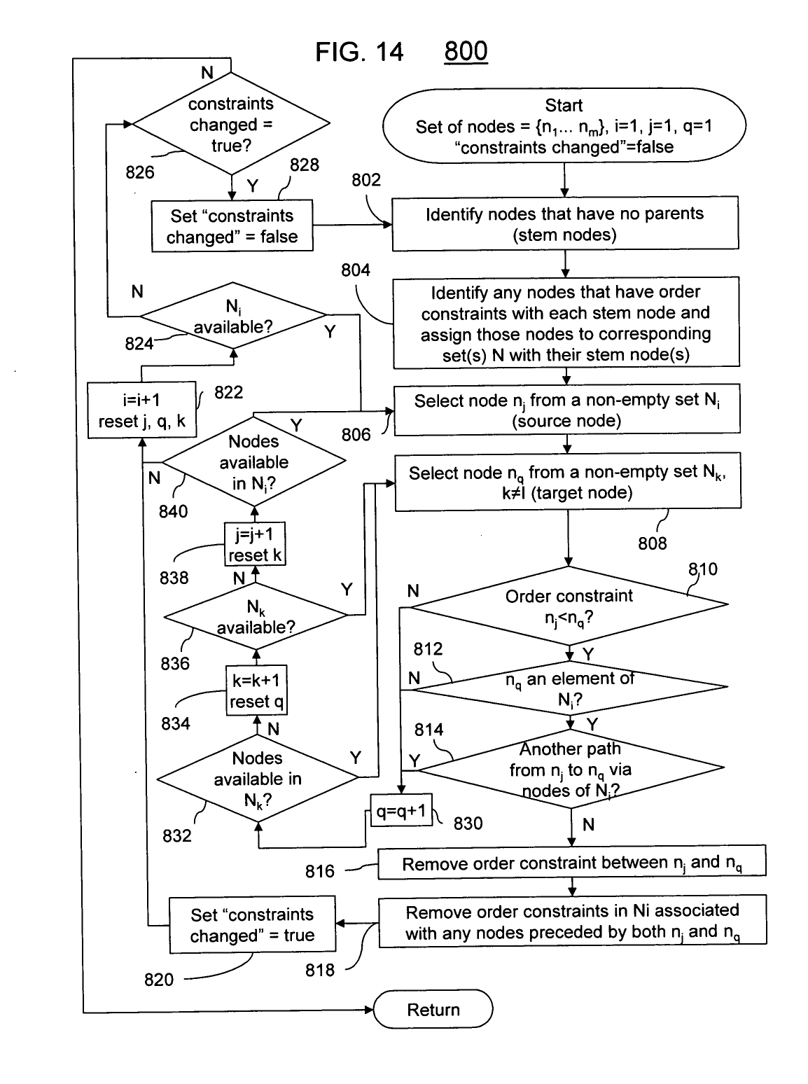

Another exemplary approach for removing one or more order constraints (e.g., corresponding to step 122 of method 600) will now be described in connection with FIG. 14. FIG. 14 illustrates an exemplary method 800 for removing one or more order constraints. The method 800 starts using as input a set of nodes=(n₁ . . . nₘ), an index i=1, an index j=1, an index q=1. At step 802, the processing system identifies nodes that have no parents from among the set of nodes. The processing system can identify nodes that have no parents simply by ordering the nodes based upon information in whatever data structure contains ordering information (e.g., and order constraints matrix such as illustrated in FIG. 7C). The nodes that are identified as having no parents may also be referred to as stem nodes herein for convenience. At step 804, the processing system identifies any nodes that have order constraints with each stem node and assigns those nodes to corresponding sets N with their respective stem nodes. These sets N can be referred to as N₁, N₂, etc. At step 806, the processing system selects a node nⱼ from a non-empty set Nᵢ. Such a node nⱼ may be referred to herein as a source node for convenience. For example, initially, i=1 and j=1, and a node n₁ is thus selected from set N₁.

At step 808 the processing system selects a node n_{q} from a non-empty set Nₖ, where k≠i. For example, the set Nₖ in the first iteration (i=1) could be set N₂ because this choice satisfies k≠i (i=1). Such a node n_{q} may be referred to herein as a target node for convenience. The processing system can choose any value of k that is not equal to the value of i. At step 810, the processing system determines whether or not there is an order constraint such that nⱼ<n_{q}. If such an order constraint exists, the processing system proceeds to step 812.

At step 812, the processing system evaluates whether n_{q} is an element of the set Ni. If the answer to this query is “yes,” the method 800 proceeds to step 814 wherein the processing system assesses whether there is another path from node nⱼ to node n_{q} via the nodes of set Nᵢ. In other words the processing system can examine whatever data structure contains the ordering information (e.g., an order constraint matrix) to assess whether the order constraints indicate that there is another potential path from a source node nⱼ to a target node n_{q} via the nodes of set Nᵢ. If the answer to the query at step 814 is “no,” the processing system proceeds to step 816 and removes the order constraint between nⱼ and n_{q}. As suggested previously, this removal can amount to actually removing the order constraint from a data structure (e.g., by erasing the entry), or by suitably flagging that particular order constraint to indicate that it has a label of “removed.” The processing system then proceeds to step 818 wherein it removes order constraints in set Nᵢ associated with any nodes preceded by both nⱼ and n_{q}.

In an exemplary variation, if the answer in step 814 is “yes” the processing system may choose to, before moving on to step 830, place the currently considered path from a source node nⱼ to a target node n_{q} via the nodes of set Nᵢ on a list of “provisionally removed” paths. This will have the effect on the subsequent executions of the method 800, when visiting step 814. Namely, the method would no longer consider any paths marked “provisionally removed” as sufficient for the answer to the question in step 814 to be “yes”. In other words, the test in the step 814 would search for other paths between the two relevant nodes that not only exist in Nᵢ, but also are not marked as “provisionally removed”.

The method 800 then proceeds to step 820 wherein it sets a variable “constraints changed” to be “true.” This is because order constraints have in fact been removed or suitably flagged at steps 818 and/or 816. The method 800 then proceeds to step 822 wherein the index i is set to i=i+1. Also, the indexes j, q, and k are reset to initial values, e.g., to values of 1. The method then proceeds to step 824 wherein the processing system assesses whether there is another set of nodes Nᵢ available. For example, if on the previous iteration i=1, at step 824 the processing system will evaluate whether or not a set N₂ is in fact available, meaning that the set N₂ exists, and that its nodes have not been previously processed at step 806 as stem nodes. If the answer to this query is “yes,” the method 800 proceeds back to step 806. If the answer to this query is “no,” the method proceeds to step 826 wherein the processing system assesses whether or not the variable “constraints changed” is equal to “true.” If “constraints changed”=“true,” the method proceeds to step 828 wherein the processing system sets the variable “constraints changed” equal to “false” prior to continuing to step 802 to repeat another iteration of the process 800.

The foregoing represents one potential path through the flow diagram of FIG. 14 based upon the particular results of the queries at steps 810, 812 and 814. It is possible that the queries at any of steps 810, 812 and 814 could cause the process to proceed to step 830 instead of to step 816 for any given iteration. For example, should the query at step 810 or 812 yield “no,” or the query at step 814 yield “yes,” the method 800 would proceed to step 830 wherein the index q will be set to q=q+1. Then, the process 800 will proceed to step 832 wherein the processing system will evaluate whether or not there are any nodes available in set Nₖ. In other words the processing system evaluates whether or not there are any target nodes in the set Nₖ that have not yet been tested relative to the source node nⱼ from the set Nᵢ. If the answer to the query at step 832 is “yes,” the process will proceed back to step 808, and another node (e.g., a random node or a next node in a sequence), will be selected from set Nₖ, and the process will continue at step 810. If, on the other hand, the query at step 832 yields the result “no,” the process will proceed to step 834 wherein the index k will be set to k=k+1, and wherein the index q will be reset, e.g., to the value 1.

The process 800 will then proceed to step 836 wherein the processing system will evaluate whether or not another set Nₖ is available, meaning that the set Nₖ exists and that its nodes have not been yet evaluated as target nodes relative to the currently selected set of stem nodes at step 806. If the answer to the query at step 836 is “yes,” the process 800 will proceed to step 808, wherein the processing system selects a node n_{q} (e.g., a random node, or an initial node in a sequence, for example) from the set Nₖ. If the answer to the query at step 836 is “no,” the method 800 proceeds to step 838 wherein the index j is set to j=j+1, and wherein the index k is reset, e.g., to an initial value 1. The process 800 then proceeds to step 840 wherein the processing system evaluates whether or not there are additional nodes available in the set Nᵢ, meaning that in the current set of nodes Nᵢ there exists remaining nodes that have not yet been tested as stem nodes. If the answer to the query at step 840 is “yes,” the process 800 proceeds back to step 806. If the answer to the query at step 840 is “no,” the process proceeds to step 822 such as previously described.

In this manner, the processing system can iterate over and test multiple sets of nodes, each of which is associated with a given stem node, so as to treat the nodes of one set as source nodes and nodes of another set as target nodes, wherein given pairs of source and target nodes can be evaluated to determine whether or not to eliminate the order constraint between them.

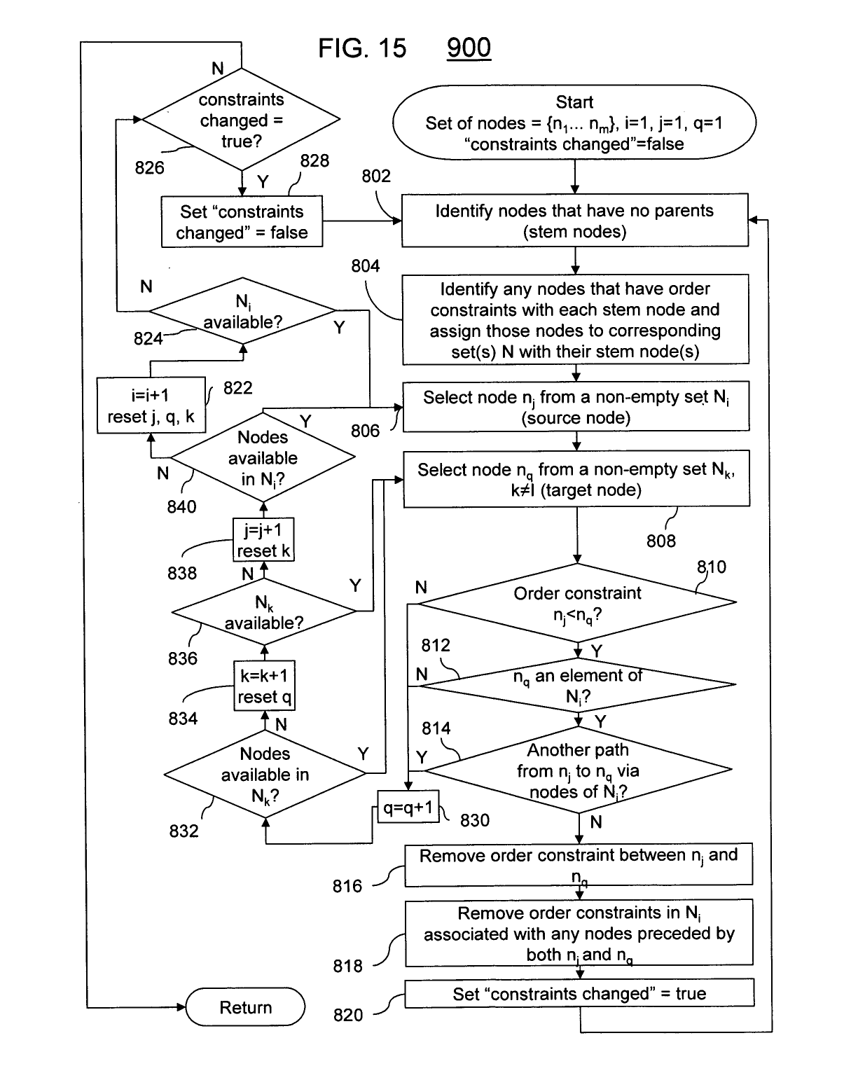

FIG. 15 illustrates another exemplary method 900 for removing one or more order constraints which is a variation of the method 800 illustrated in FIG. 14. The method 900 illustrated in FIG. 15 is similar to method 800 illustrated in FIG. 14. FIG. 15 includes the same steps as FIG. 14 which are executed in the same fashion, with one exception. Whereas the process 800 of FIG. 14 proceeds directly from step 820 to step 822, the process 900 of FIG. 15 proceeds directly from step 820 back to step 802. This has the effect of reassessing which nodes have no parents at step 802 anytime order constraints have been removed at steps 816 and 818. In other words, in contrast to the method 800 of FIG. 14, at any time order constraints are removed in method 900 of FIG. 15, the order constraint information is reassessed to newly identify any nodes that no longer have parents (stem nodes) as well as to identify any nodes that have order constraints with those newly identified stem nodes (step 804). This provides a different approach for iterating through pairs of nodes for identifying order constraints that can be removed.

Another exemplary approach for generating a workflow graph will now be described in connection with FIG. 16. FIG. 16 illustrates an exemplary method 1000 for generating a workflow graph. The method 1000 of FIG. 16 is similar to the method 100 of FIG. 6 with the exception of some additional steps and certain variations to other steps. In particular, steps 102-118 are the same as described in connection with method 100 of FIG. 6, and these steps need not be described here. FIG. 16 adds the steps 130, 132, and 134. In particular, after executing step 104 (or step 106, if step 106 is utilized) the processing system evaluates at step 130 whether the order constraints identified as step 104 are consistent with the graph model, prior to carrying out any sequence decomposition or branch decomposition. This test for consistency has been described previously in connection with FIG. 13. If it is determined at step 130 that the order constraints are not consistent with the graph model, the method 1000 proceeds to step 132 wherein the processing system removes one or more order constraints in order to obtain consistency with the graph model. For example, the processing system can carry out one of the methods 700, 800, or 900 illustrated in FIGS. 13, 14, or 15 to remove one or more order constraints at step 132. In a further variation, the processing system can be configured to identify multiple, or all, configurations of direct order constraints that, if removed, would yield order constraint information consistent with the graph model, using any of the methods 700, 800 or 900. These various configurations of removed order constraints can each yield a different workflow graph that is consistent with the model and that accurately represents the observed data to various degrees. If at step 132 the processing system removes (e.g., erases, flags, etc.) order constraints according to multiple configurations, the remaining steps 108-118 can separately operate upon each of those configurations to generate a separate workflow graph based upon the particular configuration of order constraints removed. For example, if step 132 identifies 4 configurations of order constraints that, if removed, would yield order constraint information consistent with the graph model, each configuration being different from another, steps 108 and 110 can be carried out iteratively to partition the nodes based upon a given configuration of order constraints until it is determined at step 112 that the set of nodes under a given combination of ordering constraints has been successfully partitioned. At that point, steps 116 and 118 can be executed as previously discussed. Then, at step 134 the processing system can determine whether or not other combinations of removed order constraints still exist for which partitioning can be carried out. If the answer to the query at step 134 is “yes,” the process returns back to step 108, and further partitioning in connection with steps 108 and 110 is carried out for the nodes under a different configuration of removed order constraints. The process 1000 can repeat in this manner until it is determined at step 134 that no further combinations of removed order constraints remain, at which point the process 1000 ends.

### Hardware Overview

FIG. 16 illustrates a block diagram of an exemplary computer system upon which an embodiment of the invention may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312 for displaying information to a computer user. An input device 1314, including alphanumeric and other keys, is coupled to bus 1302 for communicating information and command selections to processor 1304. Another type of user input device is cursor control 1315, such as a mouse, a trackball, or cursor direction keys for communicating direction information and command selections to processor 1304 and for controlling cursor movement on display 1312.

The exemplary methods described herein can be implemented with computer system 1300 for deriving a workflow from empirical data (case log files) such as described elsewhere herein. Such processes can be carried out by a processing system, such as processor 1304, by executing sequences of instructions and by suitably communicating with one or more memory or storage devices such as memory 1306 and/or storage device 1310 where derived workflow can be stored and retrieved, e.g., in any suitable database. The processing instructions may be read into main memory 1306 from another computer-readable medium, such as storage device 1310. However, the computer-readable medium is not limited to devices such as storage device 1310. For example, the computer-readable medium may include a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read, containing an appropriate set of computer instructions that would cause the processor 1304 to carry out the techniques described herein. The processing instructions may also be ready into main memory 1306 via a modulated wave or signal carrying the instructions, e.g., a downloadable set of instructions. Execution of the sequences of instructions causes processor 1304 to perform process steps previously described herein. In alternative embodiments, hard-wired circuitry may be used in place of or in combination with software instructions to implement the exemplary methods described herein. Moreover, the process steps described elsewhere herein may be implemented by a processing system comprising a single processor 1304 or comprising multiple processors configured as a unit or distributed across multiple machines. Thus, embodiments of the invention are not limited to any specific combination of hardware circuitry and software, and a processing system as referred to herein may include any suitable combination of hardware and/or software whether located in a single location or distributed over multiple locations.

Computer system 1300 can also include a communication interface 1316 coupled to bus 1302. Communication interface 1316 provides a two-way data communication coupling to a network link 1320 that is connected to a local network 1322 and the Internet 1328. It will be appreciated that data and workflows derived there from can be communicated between the Internet 1328 and the computer system 1300 via the network link 1320. Communication interface 1316 may be an integrated services digital network (ISDN) card or a modem to provide a data communication connection to a corresponding type of telephone line. As another example, communication interface 1316 may be a local area network (LAN) card to provide a data communication connection to a compatible LAN. Wireless links may also be implemented. In any such implementation, communication interface 1316 sends and receives electrical, electromagnetic or optical signals which carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the “Internet” 1328. Local network 1322 and Internet 1328 both use electrical, electromagnetic or optical signals which carry digital data streams. The signals through the various networks and the signals on network link 1320 and through communication interface 1316, which carry the digital data to and from computer system 1300, are exemplary forms of modulated waves transporting the information.

Computer system 1300 can send messages and receive data, including program code, through the network(s), network link 1320 and communication interface 1316. In the Internet 1328 for example, a server 1330 might transmit a requested code for an application program through Internet 1328, ISP 1326, local network 1322 and communication interface 1316. In accordance with the present disclosure, one such downloadable application can provide for deriving a workflow and an associated workflow graph as described herein. Program code received over a network may be executed by processor 1304 as it is received, and/or stored in storage device 1310, or other non-volatile storage for later execution. In this manner, computer system 1300 may obtain application code in the form of a modulated wave. The computer system 1300 may also receive data via a network, wherein the data can correspond to multiple instances of a process to be analyzed in connection with approaches described herein.

Components of the invention may be stored in memory or on disks in a plurality of locations in whole or in part and may be accessed synchronously or asynchronously by an application and, if in constituent form, reconstituted in memory to provide the information used for processing information relating to occurrences of tasks and generating workflow graphs as described herein.

### EXAMPLE 1

Consider the hypothetical data reflected in FIG. 7A and the corresponding ordering information reflected in FIGS. 7B-7E. There are eight nodes associated with this data, and these nodes are referred to as T1, T2, T3, . . . , T8 as reflected in FIGS. 7A-7E. In this example, these nodes make up the set N referred to in FIG. 8. This hypothetical data will now be discussed in connection with the exemplary method 600 shown in FIG. 12 to illustrate how the method 600 can generate a workflow graph for this hypothetical data.

Steps 102 and 104 have already been discussed in connection with the hypothetical data, and it will be assumed for the sake of this example that no potentially missing order constraints have been identified (step 106). An initial iteration of sequence decomposition identified at step 108 can be carried out according to the method 200 illustrated in FIG. 8. In particular, at step 202 sets S, P, F and Q are set to be empty. At step 204, we assume that node T1 is moved from set N to set S (e.g., the first node can be selected, but a random node could be selected instead). At step 206 a remaining node T2 of N is selected. At step 208, T2 is tested to determine if it is constrained to precede every member of S (whose contents are T1 at this point). Since the answer is “no” by inspection of FIG. 7C, the process proceeds to step 212, where T2 is tested to determine if it is constrained to follow every member of S. The answer is “no” by inspection of FIG. 7C, so T2 is moved to the set Q at step 216. The process proceeds to step 218, where it is determined that there are more nodes in N (namely, T3 through T8 remain).

The process then returns to step 206, where node T3 (a remaining node of N) can be selected. At steps 208 and 212 it is determined that T3 is not constrained to either precede or follow T1 (the current contents of S), and thus T3 is moved to set Q at step 216. The process then proceeds from step 218 back to step 206, where node T4 can be selected, tested at steps 208 and 212, and assigned to set Q at step 216. The process then proceeds from step 218 back to step 206, where node T5 can be selected, tested at steps 208 and 212, and assigned to set Q at step 216.

The process then proceeds from step 218 back to step 206, where node T6 can be selected. At step 208, it is determined that node T6 does not precede every member of S (which is T1 at this stage). At step 212, however, it is determined that node T6 does follow T1, and node T6 is assigned to set F at step 214. The process then proceeds to step 218, further looping and testing is carried out, such that nodes T7 and T8 and also assigned to set F. At this point, at step 218, no further nodes remain in set N because nodes T2, T3, T4, and T5 have been placed in set Q, and nodes T6, T7, and T8 have been placed in set F.

At step 220, it is determined that set Q is not empty. At step 22, node T2 (indicated as q in FIG. 8) can be selected (or a node can randomly be selected from Q) and moved to S. No action is taken at step 224 since there are no nodes in P. At step 226, every node in F is tested to see whether such node is constrained to precede T2 (q). By inspection of FIG. 7C, none of nodes T6, T7, or T8 are constrained to precede node T2, so none of these nodes are moved from set F to set Q at step 226. The process returns to step 220, and steps 222-226 are repeated multiple times, the result being that nodes T3, T4, and T5 are moved to set S, thereby emptying set Q, and making the contents of S={T1, T2, T3, T4, T5}.

At this point Q is empty, and the process proceeds from step 220 to step 228, where the contents of S are assigned to subset S1 (since i is currently equal to 1), and the contents of F (T6, T7 and T8) are moved back into set N. The contents of P are empty, so there is nothing in that set to move into set N. Also, the index i is incremented from 1 to 2. At step 230 it is determined that N is not empty (it contains T6, T7 and T8), and the process returns to step 202.

In this way, the processing system will further repeat the above-described process on the remaining nodes T6, T7 and T8, and will assign node T6 to subset S2 and nodes T7 and T8 to a subset S3. Thus, after a first iteration of sequence decomposition, the processing systems can identify the following three subsets such that all nodes of each subset are constrained to either precede or follow all nodes of the other subsets: S1={T1, T2, T3, T4, T5}, S2={T6}, and S3={T7, T8}.

At this stage, the process 200 of FIG. 8 has been completed, and execution returns to step 110 of process 600 of FIG. 12 to begin branch decomposition on the subsets identified by sequence decomposition at step 108. Branch decomposition can be carried out according to exemplary method 300 illustrated in FIG. 9. The process can begin using the nodes of subset S1 for analysis. That is, the set M is assigned to be M={T1, T2, T3, T4, T5. The index i is set to i=1. At step 302, sets B, K and U are assigned to be empty. At step 304, node T1 can be selected and moved from set M to set B. At step 306, it is determined that none of nodes T2, T3, T4 or T5 are constrained to either precede or follow node T1 by inspection of FIG. 7C, for example. Therefore, no nodes are moved to set K at step 306. At step 308 remaining nodes T2, T3, T4 and T5 are assigned to set U. At step 310 it is determined that set K is empty, and the process therefore proceeds to step 324. At step 324, the contents of B (namely T1) are moved into branch B1, the contents of U (namely T2, T3, T4 and T5) are moved back into set M, and i is set to i=i+1=2. At step 326 it is determined that M is not empty and the process returns to step 302.

Proceeding in this way, the processing system can also move node T2 to set B at step 304, and, by executing remaining steps, ultimately assign node T2 to its own branch B2. At this point (i=3), the set M contains nodes T3, T4 and T5. The processing system can then move node T3 to set B at step 304, and, by executing remaining steps, ultimately assign node T3 to its own branch B3.

At this point (i=4), the set M contains nodes T4 and T5. At step 304 the processing system can move node T4 to set B. At step 306 the processing system determines that node T5 is constrained to follow node T4, by inspection of FIG. 7C, for example, and assigns node T5 to set K. At step 310 it is determined that set K is not empty (it contains T5). At step 312, node T5 is moved from set K to set B (T5 is the only node in K at this point). At step 314 it is determined that set U is empty, and the process returns to step 310. At step 310 it is determined that set K is empty, and the process proceeds to step 324, where the contents of B (namely T4 and T5) are moved into branch B4. At step 326 it is determined that the set M is empty, and the process can return to carry out branch decomposition (e.g., via steps 112 and 114) on the remaining two subsets of nodes S2 and S3 identified during sequence decomposition (the processing system determines at appropriate stages that partitioning is successful at step 120 and continues the process). At this stage, the subset SI has been decomposed into parallel branches B1={T1}, B2={T2}, B3={T3} and B4={T4, T5}, where B1-B4 refer to branches of S1. To avoid confusion between how branches of various subsets are indexed, various branches can be labeled with two designators, e.g., B_{m,n,} where m refers to the subset number, and n refers to a branch of subset m. Thus, the above-noted branches can be referred to as: B_{1, 1}={T1}, B_{1, 2}={T2}, B_{1, 3}={T3} and B_{1, 4}={T4, T5}.

Since subset S2 identified during sequence decomposition contains only one node, T6, it is a trivial result that T6 comprises its own branch, and applying the above-noted algorithm to S2 will assign T2 to its own branch, and this single branch of S2 can be labeled B_{2, 1}={T6}.

By applying branch decomposition to S3={T7, T8}, the processing system can assign nodes T7 and T8 to separate parallel branches B_{3, 1}={T7} and B_{3, 2}={T8}. In particular, at step 304 of FIG. 9, node T7 can be moved to set B. At step 306, it is determined that T8 is not constrained to follow or precede T7 (they are exclusive by inspection of FIG. 7C, for example), so T8 is not assigned to set K. At step 308, node T8 is moved to set U. At step 310 it is determined that K is empty, and at step 324, the contents of B (namely T7) are moved to branch B1 of the third subset, which can be designated B_{3, 1}. The contents of U (namely T8) are moved back into set M and index i is set to i=1+1=2. At step 326, it is determined that set M is not empty (it contains T8), and the process returns to step 302. Further execution identifies T8, the last remaining node to comprise its own branch, i.e., B_{3, 2}={T8}, parallel to branch B_{3, 1}={T7}.

Thus, at this stage, sequence decomposition yields S1={T1, T2, T3, T4, T5}, S2={T6}, and S3={T7, T8}, and branch decomposition yields branches B_{1, 1}={T1}, B_{1, 2}={T2}, B_{1, 3}={T3} and B_{1, 4}={T4, T5} within S1, branch B_{2, 1}={T6} within S2, and branches B_{3, 1}={T7} and B_{3, 2}={T8} within S3. Further sequence decomposition need only be carried out on branch B_{1, 4}={T4, T5}, since the other branches contain single nodes, yielding that T4 precedes T5.

What remains is to identify which branches are executable together and which branches are executable as alternatives (i.e., which branches are AND branches and which branches are OR branches) (step 116 of FIG. 12). This aspect can be carried using exemplary method 400 shown in FIG. 10, for which step 408 can be carried out according to the exemplary method 500 shown in FIG. 11.

For example, the method 400 in FIG. 10 can begin with the set of branches of set S1 as input, i.e., branches B_{1, 1}={T1}, B_{1, 2}={T2}, B_{1, 3}={T3} and B_{1, 4}={T4, T5} in this example. At step 402, the number of branches is not equal to 1, so the method proceeds to step 404. At step 404, the quantity F1(Bi, Bj) is calculated for i=1 to r (r=4 for S1), Where F1(Bi, Bj)=“true” if any node of Bi occurs with any nodes of Bj, and where F1(Bi, Bj)=“false” otherwise. The result is shown in Table 1 below, based on inspection of FIG. 7C, for example:

TABLE 1
Values for F1(Bi, Bj).

| | B_{1, 1} | B_{1, 2} | B_{1, 3} | B_{1, 4} |
|---|---|---|---|---|
| B_{1, 1} | — | T | T | T |
| B_{1, 2} | T | — | F | T |
| B_{1, 3} | T | F | — | T |
| B_{1, 4} | T | T | T | — |

At step 406, the processing system calculates another function F2(Bi, Bj) for i=1 to r (r=4 for S1), j>i, where F2=“true” if r=2, or if F1(Bi, Bj)=F1(Bj, Bk) for all Bk≠Bi, Bj, and where F2(Bi, Bj)=“false” otherwise. Here, r is not equal to 2 (rather, r=4). Thus, the result of this step is shown in Table 2 below:

TABLE 2
Values for F2(Bi, Bj).

| | B_{1, 1} | B_{1, 2} | B_{1, 3} | B_{1, 4} |
|---|---|---|---|---|
| B_{1, 1} | — | F | F | T |
| B_{1, 2} | — | — | T | F |
| B_{1, 3} | — | — | — | F |
| B_{1, 4} | — | — | — | — |

At step 408, the above noted branches are arranged into groups. This step can be carried according to exemplary method 500 shown in FIG. 11. The method 500 starts with the above-noted four branches of S1 as input, and an index i is set to i=1. At step 502 branch B1 (B_{1, 1} in this example) is selected. At step 504, it is determined that B1 is not already assigned to a group, and so B1 is assigned to group G1 at step 510, and index j is set to j=i+1=2. At step 512, branch B2 (B_{1, 2} in this example) is selected. At step 514 it is determined that branch B2 is not already assigned to a group. Thus, at step 520, the processing system tests whether F2(B1, B2) is true or not. Since F2(B1, B2) is false from Table 2 above, the process proceeds to step 516 where j is set to j=j+1=3. At step 518, j is determined to be less than r (r=4), and branch B3 is thus selected at step 512. At step 514 it is determined that branch B3 is not already assigned to a group, and at step 520 it is determined that F2(B1, B3)=false. The process proceeds to step 516, where j is incremented to j=4, and the process proceeds back to step 514 via step 516. At step 514 it is determined that B4 is not assigned to a group, and at step 520 it is determined that F2(B1, B4)=true. Thus at step 522, branch B4 (B_{1, 4} in this example) is assigned to group G1 along with branch B_{1, 1}.

At step 516 j is incremented to j=5, which is not less than r=4 (step 518) and the process thus proceeds to step 506 where i is incremented to i=2. Since i is less than r=4 (step 508) the process selects branch B2 (B_{1, 2} in this example) at step 502. Branch B2 has not previously been assigned to a group (step 504), so at step 510, branch B2 is assigned to group G2, and j is incremented to j=i+1=3. At step 512, branch B3 is selected (B_{1, 3} in this example). B3 is not already assigned to a group (step 514), so at step 520, branch B3 is tested in relation to branch B2 to determine if F2(B2, B3)=true. By Table 2, it is seen that F2(B2, B3)=true, and therefore, at step 522, branch B3 is assigned to group G2 along with branch B2 (B_{1, 3} and B_{1, 2} are grouped together).

At this point, all four branches of subset S1 have been assigned to groups, and the process will ultimately reach the conclusion at step 508 that i is not less than r, and the process will return to process 400 at step 410 (FIG. 10). At step 410, the two groups G1 and G2 with two branches each will be analyzed to determine whether the branches of those groups should be connected by AND nodes or OR nodes. For group G1={B_{1, 1,} B_{1, 4}}, it is determined at step 410 that F1=true, and these branches therefore stem from an AND node. For group G2={B_{1, 2,} B_{1, 3}}, it is determined at step 410 that F1=false, and these branches therefore stem from an OR node.

At step 412, each of the groups G1 and G2 is designated as a new branch, and the number of branches is reset, in this example, to 2 branches. The process 400 is then repeated on those two new branches. That is new values for F1 and F2 are recalculated based on the designation of the two groups as branches. The result of this process is that the two new “combination” branches stem from an AND node. They will then be designated at step 412 as a single branch, and the process 400 will terminate at step 402 because the number of branches will have reached r=1.

By similarly applying the process 400 to the two branches of subset S3={T7, T8}, the processing system will determine that those nodes, each being its own branch, stem from an OR node. Execution then returns to step 118 of method 600 shown in FIG. 12, where the workflow graph can be constructed based upon the information thus determined by connecting the various nodes representing with edges in appropriate sequence order and by inserting AND and/or OR nodes with edges where appropriate, namely, in summary:

subsets S1, S2 and S3 occur in that sequence order;

S1={T1, T2, T3, T4, T5}, S2={T6}, and S3={T7, T8};

branches B_{1, 1}={T1}, B_{1, 2}={T2}, B_{1, 3}={T3} and B_{1, 4}={T4, T5} occur within S1;

branch B_{2, 1}={T6} occurs within S2;

branches B_{3, 1}={T7} and B_{3, 2}={T8} occur within S3;

branches B_{1, 2} and B_{1, 3} stem from an OR node;

branches B_{1, 1} and B_{1, 4} stem from an AND node;

combination branch B_{1, 2}/B_{1, 3} and combination branch B_{1, 1}/B_{1, 4} stem from an AND node;

branches B_{3, 1}and B_{3, 2} of subset S3 stem from an OR node.

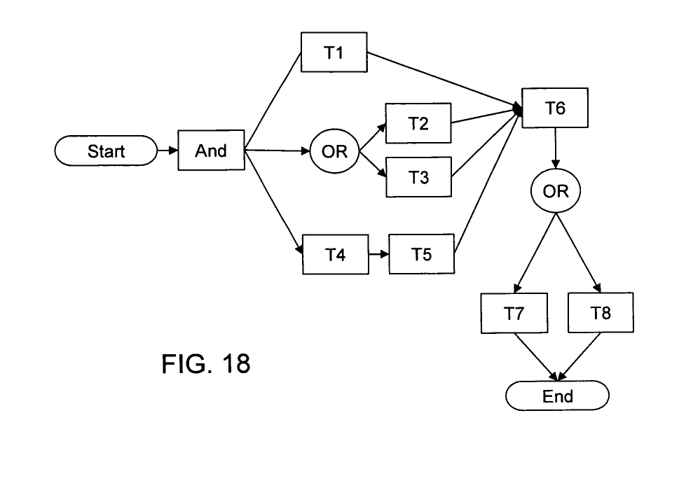

FIG. 18 illustrates a pictorial workflow graph resulting from this process.

### EXAMPLE 2

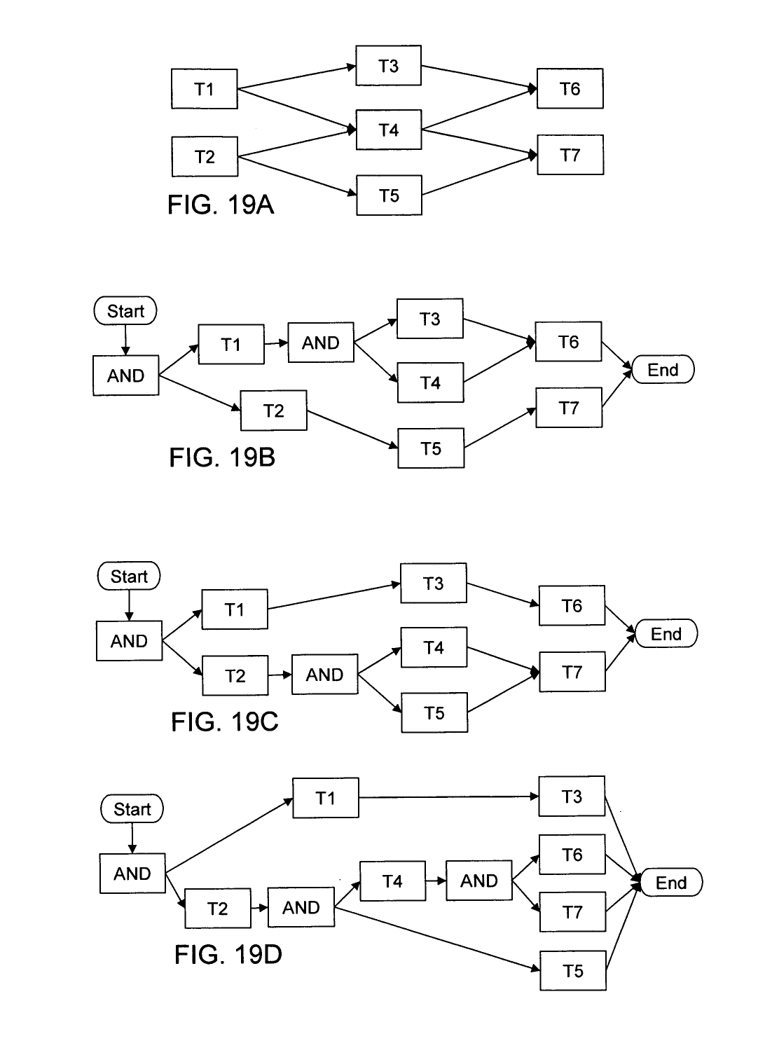

Examples relating to removing order constraints to facilitate sequence and branch decomposition will now be described. Consider a set of tasks having order constraints such a graph of the corresponding nodes is illustrated as shown in FIG. 19A. A process with this set of order constraints is not consistent with the model because nodes that are siblings do not necessarily share exactly the same parents. Order constraints can be removed from the corresponding data structure containing order constraint information so as to make the data consistent with the graph model according to the methods illustrated in FIGS. 13, 14 and 15. For FIG. 19A, three possible consistent final graphs are shown in FIGS. 19B-19D.

With reference to the method 700 of FIG. 13, the process 700 will first determine whether any single direct constraint (i.e., n=1 initially) can be removed to create a consistent graph. Since there are multiple branch connections between the first and second layers and the second and third layers, there will be no consistent solution generated by removing any single direct order constraint. Therefore, the process 700 will increment n to n=2 at step 716 and repeat. The process will examine combinations of two constraints for removal. By iterating through the steps, the process 700 will determine that removing direct constraints T2→T4 and T4→T7 yields data consistent with the graph model as pictorially illustrated in FIG. 19B. Removing direct constraints T1→T4 and T4→T6 yields data consistent with the graph model as pictorially illustrated in FIG. 19C. These are the only two consistent graphs that can be created by removing two direct constraints. Either of these configurations could be generated by the process 700 of removing order constraints. Also, as reflected by the loop stemming from step 134 of method 1000 (FIG. 16), the overall method can return workflow graphs corresponding to both of these possibilities. Note that removing direct order constraints also breaks several indirect order constraints.

As noted previously, in a variation, steps 702-712 can be repeated until multiple, (e.g., all) sets of direct order constraints of size n have been tested. If more than one set of direct order constraints of size n can be removed to create a consistent workflow graph, all of these potential solutions can be processed and corresponding workflow graphs can be returned, and a human domain expert can choose among them, if desired. For example, both graphs corresponding to FIGS. 19B and 19C could be returned. Also, removing three direct order constraints, T1→T4, T3→T6, and T5→T7, yields data consistent with the graph model as pictorially illustrated in FIG. 19D. This solution can be considered less optimal than the previous two solutions, because it requires removing a greater number of direct order constraints. As it is shown in FIG. 13, the method 700 would end before generating this latter solution since it would identify data consistent with the graph model by removing fewer order constraints as described above. However, in the variation of returning all solutions that involve removing configurations of direct order constraints up to a given number of constraints (e.g., up to and including 3 direct order constraints), the latter solution could be returned along with, perhaps, others. The above-described solutions can also be obtained by executing methods 800 and 900 to remove order constraints in the examples of FIGS. 14 and 15, respectively, with or without the variation described for method 700, on this hypothetical data.

While this invention has been particularly described and illustrated with reference to particular embodiments thereof, it will be understood by those skilled in the art that changes in the above description or illustrations may be made with respect to form or detail without departing from the spirit or scope of the invention.

What is claimed is:

1. A method for generating a workflow graph, the method comprising:
obtaining data corresponding to multiple instances of a process, the process including a set of tasks, the data including information about order of occurrences of the tasks;
analyzing the occurrences of the tasks to identify order constraints among the tasks;
partitioning nodes representing tasks into subsets based upon the order constraints, wherein the subsets are sequence ordered with respect to each other such that all nodes associated with a given subset either precede or follow all nodes associated with another subset;
partitioning nodes representing tasks into subgroups, wherein each subgroup includes one or more nodes that occur without order constraints relative to nodes associated with other subgroups; and
constructing a workflow graph representative of the process and representative of relationships between said subsets and said subgroups wherein nodes are connected by edges.

2. The method of claim 1, comprising:
for a given subgroup that comprises more than one node, further partitioning the subgroup into further subsets of nodes based upon sequence order relationships corresponding to the nodes of the given subgroup; and
for the further subsets that comprise more than one node, partitioning each of those subsets into further subgroups of nodes, wherein each further subgroup of a given one of the further subsets includes nodes that occur without order constraints relative to nodes associated with other further subgroups of the given subset.

3. The method of claim 1, comprising:
repeating the partitioning nodes representing tasks into subsets and the partitioning nodes representing tasks into subgroups iteratively, wherein said partitioning nodes representing tasks into subgroups processes previously identified subsets, and wherein said partitioning nodes representing tasks into subsets processes previously identified subgroups.

4. The method of claim 3, wherein said repeating the partitioning nodes representing tasks into subsets and the partitioning nodes representing tasks into subgroups is carried out iteratively until each subset is reduced to a single node.

5. The method of claim 1, comprising:
identifying any of said subgroups executable with any other ones of said subgroups; and
identifying any of said subgroups executable as alternatives to any other ones of said subgroups.

6. The method of claim 3, comprising:
grouping subgroups identified as executable as alternatives to other ones of said subgroups together and designating the grouping as a new subgroup; and
iteratively repeating said steps of identifying any of said subgroups executable with any other ones of said subgroups and identifying any of said subgroups executable as alternatives to any other ones of said subgroups, wherein said step of iteratively repeating processes the designated new subgroup along with other subgroups.

7. The method of claim 1, wherein analyzing the occurrences of the tasks to identify order constraints among the tasks comprises counting a number of times one occurrence of a task occurs before or after another occurrence of a task.

8. The method of claim 1, wherein said analyzing the occurrences of the tasks comprises identifying and correcting possible missing order constraints.

9. The method of claim 1, wherein analyzing the occurrences of the tasks to identify sequence order relationships among the tasks comprises:
storing information identifying pairs of tasks observable together but for which no order constraint is observable;
storing information identifying pairs of tasks not observable together; and
storing information specifying order constraints for pairs of tasks for which the order constraints are observable.

10. The method of claim 1, wherein partitioning nodes representing tasks into subsets based upon the order constraints comprises:
(a) selecting a node from a set of nodes representing tasks and assigning said node to a given subset;
(b) assigning nodes not assigned to the given subset to another subset unless said nodes not assigned to the given subset either precede or follow all nodes assigned to the given subset based upon the order constraints;
(c) while nodes of said another subset remain, assigning one or more of the nodes of said another subset to the given subset, and repeating step (b) after each such assignment; and
(d) if any nodes of the set of nodes remain unassociated with any subset, assigning one of the remaining unassociated nodes to a new subset, and repeating steps (b) and (c) using the new subset in place of the given subset.

11. The method of claim 1, wherein partitioning nodes representing tasks into subgroups comprises:
(a) selecting a node from a set of nodes representing tasks and assigning said node to a given subgroup;
(b) assigning nodes not assigned to the given subgroup to another subgroup if said nodes not assigned to the given subset possess order constraints with any nodes of the given subgroup;
(c) while nodes of said another subgroup remain, assigning one or more of the nodes of said another subgroup to the given subgroup, and repeating step (b) after each such assignment; and
(d) if any nodes of the set of nodes remain unassociated with any subgroup, assigning one of the remaining unassociated nodes to a new subgroup, and repeating steps (b) and (c) using the new subgroup in place of the given subgroup.

12. The method of claim 1, comprising removing one or more order constraints to facilitate said partitioning nodes representing tasks into subsets and said partitioning nodes representing tasks into subgroups.

13. A system for generating a workflow graph, comprising:
a processing system; and
a memory coupled to the processing system, wherein the processing system is configured to execute steps of:
obtaining data corresponding to multiple instances of a process, the process including a set of tasks, the data including information about order of occurrences of the tasks;
analyzing the occurrences of the tasks to identify order constraints among the tasks;
partitioning nodes representing tasks into subsets based upon the order constraints, wherein the subsets are sequence ordered with respect to each other such that all nodes associated with a given subset either precede or follow all nodes associated with another subset;
partitioning nodes representing tasks into subgroups, wherein each subgroup includes one or more nodes that occur without order constraints relative to nodes associated with other subgroups; and
constructing a workflow graph representative of the process and representative of relationships between said subsets and said subgroups wherein nodes are connected by edges.

14. The system of claim 13, wherein the processing system is configured to execute steps of:
for a given subgroup that comprises more than one node, further partitioning the subgroup into further subsets of nodes based upon sequence order relationships corresponding to the nodes of the given subgroup; and
for the further subsets that comprise more than one node, partitioning each of those subsets into further subgroups of nodes, wherein each further subgroup of a given one of the further subsets includes nodes that occur without order constraints relative to nodes associated with other further subgroups of the given subset.

15. The system of claim 13, wherein the processing system is configured to execute a step of:
repeating the partitioning nodes representing tasks into subsets and the partitioning nodes representing tasks into subgroups iteratively, wherein said partitioning nodes representing tasks into subgroups processes previously identified subsets, and wherein said partitioning nodes representing tasks into subsets processes previously identified subgroups.

16. The system of claim 15, wherein said repeating the partitioning nodes representing tasks into subsets and the partitioning nodes representing tasks into subgroups is carried out iteratively until each subset is reduced to a single node.

17. The system of claim 13, wherein the processing system is configured to execute steps of:
identifying any of said subgroups executable with any other ones of said subgroups; and
identifying any of said subgroups executable as alternatives to any other ones of said subgroups.

18. The system of claim 13, wherein the processing system is configured to execute a step of:
removing one or more order constraints to facilitate said partitioning nodes representing tasks into subsets and said partitioning nodes representing tasks into subgroups.

19. A computer readable medium comprising executable instructions for generating a workflow graph, wherein said executable instructions comprise instructions adapted to cause a processing system to execute steps of:
obtaining data corresponding to multiple instances of a process, the process including a set of tasks, the data including information about order of occurrences of the tasks;
analyzing the occurrences of the tasks to identify order constraints among the tasks;
partitioning nodes representing tasks into subsets based upon the order constraints, wherein the subsets are sequence ordered with respect to each other such that all nodes associated with a given subset either precede or follow all nodes associated with another subset;
partitioning nodes representing tasks into subgroups, wherein each subgroup includes one or more nodes that occur without order constraints relative to nodes associated with other subgroups; and
constructing a workflow graph representative of the process and representative of relationships between said subsets and said subgroups wherein nodes are connected by edges.

20. The computer readable medium of claim 19, wherein said executable instructions comprise instructions adapted to cause a processing system to execute steps of:
for a given subgroup that comprises more than one node, further partitioning the subgroup into further subsets of nodes based upon sequence order relationships corresponding to the nodes of the given subgroup; and
for the further subsets that comprise more than one node, partitioning each of those subsets into further subgroups of nodes, wherein each further subgroup of a given one of the further subsets includes nodes that occur without order constraints relative to nodes associated with other further subgroups of the given subset.

21. The computer readable medium of claim 19, wherein said executable instructions comprise instructions adapted to cause a processing system to execute a step of:
repeating the partitioning nodes representing tasks into subsets and the partitioning nodes representing tasks into subgroups iteratively, wherein said partitioning nodes representing tasks into subgroups processes previously identified subsets, and wherein said partitioning nodes representing tasks into subsets processes previously identified subgroups.

22. The computer readable medium of claim 21, wherein said repeating the partitioning nodes representing tasks into subsets and the partitioning nodes representing tasks into subgroups is carried out iteratively until each subset is reduced to a single node.

23. The computer readable medium of claim 19, wherein said executable instructions comprise instructions adapted to cause a processing system to execute steps of:
identifying any of said subgroups executable with any other ones of said subgroups; and
identifying any of said subgroups executable as alternatives to any other ones of said subgroups.

24. The computer readable medium of claim 19, wherein said executable instructions comprise instructions adapted to cause a processing system to execute a step of:
removing one or more order constraints to facilitate said partitioning nodes representing tasks into subsets and said partitioning nodes representing tasks into subgroups.
